(19) United States
(12) Patent Application Publication
(10) Pub. No.: US 2021/0133659 A1
(43) Pub. Date: May 6, 2021

(54) ESTIMATION MANAGEMENT SYSTEM

(71) Applicant: Hitachi, Ltd., Tokyo (JP)

(72) Inventors: Kenji FUJIHIRA, Tokyo (JP); Takeshi ITO, Tokyo (JP); Koichiro NAGATA, Tokyo (JP)

(21) Appl. No.: 17/071,011

(22) Filed: Oct. 15, 2020

(30) Foreign Application Priority Data
Oct. 30, 2019 (JP) 2019-197469

(51) Int. Cl. G06Q 10/06; G06Q 10/00; G06Q 30/02; G06Q 10/10; G05B 23/02

(52) U.S. Cl. CPC G06Q 10/06375; G06Q 10/20; G05B 23/024; G06Q 10/067; G06Q 10/10; G06Q 30/0283

(57) ABSTRACT

An estimation management system stores a plurality of past estimations each including a proposed plan and a compared plan. The estimation management system accepts input of a trial calculation condition including a plurality of trial calculation condition items for a user to create a new estimation, and sets, as a value of an unentered item in the plurality of trial calculation condition items, a value of a trial calculation condition item of each of a plurality of estimations selected from the plurality of past estimations to make a trial calculation. The estimation management system generates a plurality of trial calculation results corresponding to the plurality of estimations, and evaluates the plurality of trial calculation results in terms of a total cost and a period required for superiority.

### CLAIM OF PRIORITY

The present application claims priority from Japanese patent application JP 2019-197469 filed on Oct. 30, 2019, the content of which is hereby incorporated by reference into this application.

### BACKGROUND OF THE INVENTION

### 1. Field of the Invention

The present invention relates to an estimation management system.

### 2. Description of the Related Art

Industrial plants that manufacture products such as petrochemical products, cement, rubber, and industrial gas are required to operate stably and safely for a long period of time. Meanwhile, decades have passed since construction, which deteriorates facilities, and thus, the needs for replacement of the facilities and maintenance of the facilities are increasing. The facilities operated in these industrial plants include industrial products such as electric motors, compressors, and pumps. The industrial products are operated for a long period of about 20 to 50 years, and if the industrial products that play a central role in a manufacturing process stop, the entire production process will stop. Thus, the industrial products are required to have stability to operate without failure for a long period of time.

When an industrial product maker receives an inquiry about purchase of an industrial product or a contract for a maintenance service from an industrial plant operator who is a client, the industrial product maker creates a rough estimation proposal that meets performance and a budget requested by the client and makes a proposal to the client. Specifically, first, a sales staff of the industrial product maker confirms, with the client, requirement specifications for the industrial product, such as the physical size and power consumption, and requests an estimator of the industrial product maker to create an estimation. The estimator creates the estimation in accordance with the requirement specifications of the client. The sales staff confirms the estimation created by the estimator and explains the estimation to the client.

The estimator considers not only technical conditions such as the power consumption and output of the industrial product, but also operating conditions such as the purpose for which the client uses the industrial product, an operating environment, and an operating frequency of the industrial product, to create an estimation proposal that meets the requirements of the client. In order to carry out this task, the estimator is required to have an understanding of technical information details of the industrial product. In addition to this, in order to create an estimation proposal that enables safe and stable operation for a long period of time, the estimator is required to have knowledge about rules of thumb regarding failure risks according to operating conditions, methods for reducing the failure risks, and the like.

For large industrial products, an initial investment cost is as high as 10 million yen or more, and long-term maintenance and operation are presupposed. Therefore, when the industrial product is proposed to the industrial plant operator, it is necessary to show superiority in terms of a cumulative cost in an expected operation period in order to make a highly appealing proposal. Furthermore, in order for the industrial plant operator to examine purchasing the industrial product or its maintenance service early, the industrial product maker is required to efficiently create an estimation proposal for the industrial product or the maintenance service in a short time.

As a technique for proposing an estimation to a client based on the cumulative cost, there is a turbine maintenance support system disclosed in JP 2004-258858 A. JP 2004-258858 A discloses the maintenance support system and a method in which, for proposing a turbine component replacement time, cumulative costs in cases of replacing components and not replacing the components are displayed in a time series graph, and a timing at which lines in the graph intersect is proposed as the replacement time. By applying this technique to creation of the estimation proposal for the industrial product, the sales staff can present a plurality of plans to the client in a comparable manner and propose a superior plan in terms of the cumulative cost.

Furthermore, as a technique for efficiently creating an estimation, there is an estimation creating system for air-conditioning facility works disclosed in JP 2016-103135 A. JP 2016-103135 A discloses the estimation creating system for air-conditioning facility works that has a function of searching for past similar estimation information by use of an air-conditioning area, air-conditioning capacity, and air-conditioning model as keys, and diverting the past similar estimation information to create an estimation. By applying the technique disclosed in this patent to the creation of the estimation proposal for the industrial product, it is possible to search for a similar past estimation by use of the requirement specifications of the client and operating conditions as keys, and divert the similar past estimation to create an estimation for a new project. As a result, the estimator can efficiently create the estimation proposal as compared with a case of creating the estimation for the new project from scratch.

### SUMMARY OF THE INVENTION

Introducing and operating an industrial product involves a high initial cost and a long-term operating cost. Therefore, a plan with a low operating cost and a high initial cost is superior to a plan with a low initial cost and a high operating cost in terms of the cumulative cost after a certain period of time has passed since a start of operation. Therefore, in order to create a highly appealing estimation proposal to an industrial plant operator who is a client, it is required to present a proposed plan and a compared plan in a comparable manner, and to show superiority in terms of minimizing the cumulative cost in the expected operation period and shortening a period required for the proposed plan to be superior to the compared plan in terms of the cumulative cost.

In order to create a highly appealing estimation proposal in terms of these points, it is necessary for an estimator to be an expert who has knowledge not only about technical information details of the industrial product but also about rules of thumb regarding failure risks or the like according to operating conditions and avoidance of the failure risks.

However, there has been a problem that if the number of inquiries about facility renewal of industrial products and maintenance contracts increases with the deterioration of facilities of the industrial plants, estimators who have knowledge to create estimation proposals are insufficient for the number of the inquiries. As a result, there has been a problem that a proposal of an industrial product or its maintenance service is delayed, and a period for an industrial plant operator who is a client to examine necessity of purchasing the industrial product or contracting its maintenance service is prolonged.

If the technique disclosed in JP 2004-258858 A is applied, the period required for the proposed plan to be superior to the compared plan in terms of the cumulative cost (hereinafter referred to as period required for superiority), and the cumulative cost in the entire expected operation period of the proposed plan (hereinafter, referred to as total cost) can be presented to the client. However, in order to create a highly appealing estimation proposal in terms of the period required for superiority and the total cost, for example, it has been necessary to repeat the work of correcting components to be used, a component replacement frequency, contents of a provided service, or the like, and making a trial calculation of the cumulative cost. Therefore, there is a problem that a person in charge who does not have knowledge about the design or maintenance of the industrial product cannot create an estimation proposal superior in terms of the period required for superiority and the total cost.

Furthermore, by applying the technique disclosed in JP 2016-103135 A, it is possible to search estimations created in the past for an estimation that has similar estimation conditions. However, there has been a problem that when the past estimation searched for and selected is diverted to create an estimation for a new project, it is not possible to confirm the superiority that can be shown in terms of the period required for superiority and the total cost, and thus, it is not possible to create a highly appealing estimation proposal.

The present invention aims to enable a non-expert to create a highly appealing estimation proposal to a client in terms a period required for superiority and a total cost when a new estimation proposal is created, and to improve efficiency of creating the estimation proposal and shorten a proposal period.

One aspect of the present invention is an estimation management system that creates and manages an estimation of a cost incurred for introduction of a device or a maintenance service. The estimation management system includes one or more processors, and one or more storage devices. The one or more storage devices store a plurality of past estimations each including a proposed plan and a compared plan, and each of the plurality of past estimations includes a trial calculation condition for a trial calculation of a cost in an estimation period, a transition of a cumulative cost of the proposed plan in the estimation period, a trial calculation condition for a trial calculation of a cost of the compared plan in the estimation period, a transition of the cumulative cost of the compared plan in the estimation period, and a period required for superiority that represents a period required for the cumulative cost of the proposed plan to fall below the cumulative cost of the compared plan. The one or more processors accept input of a trial calculation condition including a plurality of trial calculation condition items for a user to create a new estimation, set, as a value of an unentered item in the plurality of trial calculation condition items, a value of a trial calculation condition item of each of a plurality of estimations selected from the plurality of past estimations to make a trial calculation, generate a plurality of trial calculation results corresponding to the plurality of estimations, evaluate the plurality of trial calculation results in terms of a total cost and the period required for superiority, and determine trial calculation results to be presented to the user from among the plurality of trial calculation results based on evaluation of the plurality of trial calculation results.

According to one aspect of the present invention, it is possible for a non-expert to create a highly appealing estimation proposal to a client in terms of a period required for superiority and a total cost.

### BRIEF DESCRIPTION OF THE DRAWINGS

FIG. 1 is a block diagram illustrating a configuration example of an estimation management system of an embodiment;

FIG. 2 is a block diagram illustrating an example of a configuration of an estimation management server of the embodiment;

FIG. 3A is an explanatory diagram illustrating an example of a similarity calculation parameter management table of the embodiment;

FIG. 3B is an explanatory diagram illustrating an example of the similarity calculation parameter management table of the embodiment;

FIG. 4 is a sequence diagram illustrating an example of setting similarity calculation parameters of the embodiment;

FIG. 5 is a flowchart illustrating an example of a similarity calculation parameter setting unit of the embodiment;

FIG. 6A is an explanatory diagram illustrating an example of a similarity management table of the embodiment;

FIG. 6B is an explanatory diagram illustrating an example of the similarity management table of the embodiment;

FIG. 6C is an explanatory diagram illustrating an example of the similarity management table of the embodiment;

FIG. 6D is an explanatory diagram illustrating an example of the similarity management table of the embodiment;

FIG. 7A is an explanatory diagram illustrating an example of an estimation unit trial calculation condition temporary management table of the embodiment;

FIG. 7B is an explanatory diagram illustrating an example of the estimation unit trial calculation condition temporary management table of the embodiment;

FIG. 7C is an explanatory diagram illustrating an example of the estimation unit trial calculation condition temporary management table of the embodiment;

FIG. 8A is an explanatory diagram illustrating an example of a plan unit trial calculation condition temporary management table of the embodiment;

FIG. 8B is an explanatory diagram illustrating an example of the plan unit trial calculation condition temporary management table of the embodiment;

FIG. 8C is an explanatory diagram illustrating an example of the plan unit trial calculation condition temporary management table of the embodiment;

FIG. 8D is an explanatory diagram illustrating an example of the plan unit trial calculation condition temporary management table of the embodiment;

FIG. 9A is an explanatory diagram illustrating an example of a trial calculation result temporary management table of the embodiment;

FIG. 9B is an explanatory diagram illustrating an example of the trial calculation result temporary management table of the embodiment;

FIG. 9C is an explanatory diagram illustrating an example of the trial calculation result temporary management table of the embodiment;

FIG. 10 is an explanatory diagram illustrating an example of an estimation unit trial calculation condition management table of the embodiment;

FIG. 11 is an explanatory diagram illustrating an example of a plan unit trial calculation condition management table of the embodiment;

FIG. 12 is an explanatory diagram illustrating an example of an estimation result management table according to the embodiment;

FIG. 13A is an explanatory diagram illustrating an example of a cumulative cost transition table of the embodiment;

FIG. 13B is an explanatory diagram illustrating an example of the cumulative cost transition table of the embodiment;

FIG. 13C is an explanatory diagram illustrating an example of the cumulative cost transition table of the embodiment;

FIG. 14 is an explanatory diagram illustrating an example of a component replacement interval input range management table of the embodiment;

FIG. 15 is a sequence diagram illustrating an example of a temporary trial calculation of a new estimation of the embodiment;

FIG. 16 is a flowchart illustrating an example of a similarity determination unit of the embodiment;

FIG. 17 is a flowchart illustrating an example of a temporary trial calculation function unit of the embodiment; and

FIG. 18 is a sequence diagram illustrating an example of a temporary trial calculation result display screen of a new estimation of the embodiment.

### DESCRIPTION OF THE PREFERRED EMBODIMENTS

An embodiment of the present invention will be described below with reference to the accompanying drawings. The embodiment described below relates to estimation creation, for example, to an estimation management system and an estimation calculation method that support estimation creation for a client proposal targeting an industrial plant. An estimation is created for a cost incurred for introduction of a device or a maintenance service. A type of device to be estimated is not particularly limited, but an estimation calculation of the present embodiment has a high effect on an estimation for purchasing an industrial product or a maintenance service for an industrial product or an industrial plant, for example.

The estimation management system quotes an estimation created in the past when creating a new estimation proposal. With this quotation, it is possible for a non-expert to create a highly appealing estimation proposal to a client in terms of a period required for superiority and a total cost. As a result, it is possible for an industrial product maker to improve efficiency of creating an estimation proposal and shorten a proposal period, and thus, it is possible to concentrate resources of experts on creation of proposals for more important clients, for example, in terms of expected sales scale. Furthermore, it is possible for the client to reduce the number of meetings with the industrial product maker and a meeting time. As a result, it is possible to shorten a period for examining necessity of introducing the industrial product and making a maintenance contract.

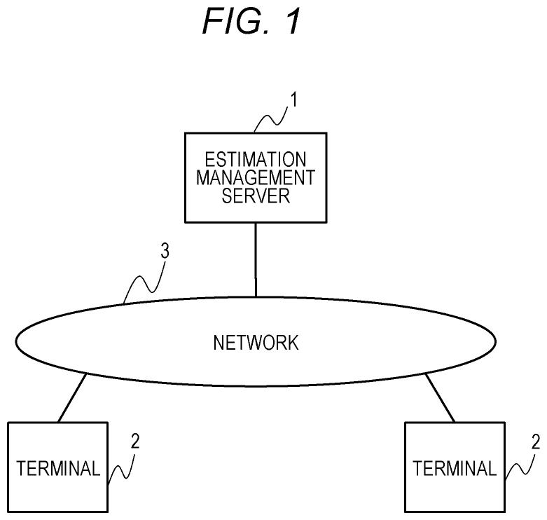

FIG. 1 is a block diagram illustrating a configuration example of the estimation management system. The estimation management system includes an estimation management server 1 and a plurality of terminals 2. FIG. 1 illustrates two terminals 2 as an example. The estimation management server 1 and the plurality of terminals 2 are connected by a network 3.

When the plurality of terminals 2 is connected to the estimation management server 1 via the network 3, an administrator of the estimation management system in the industrial product maker, who is a user of the estimation management system, and a user in charge who creates and proposes an estimation proposal for a client in charge by use of the estimation management system can use the estimation management system using their own terminals. Note that an input/output device of the estimation management server 1 may be used instead of the terminals 2.

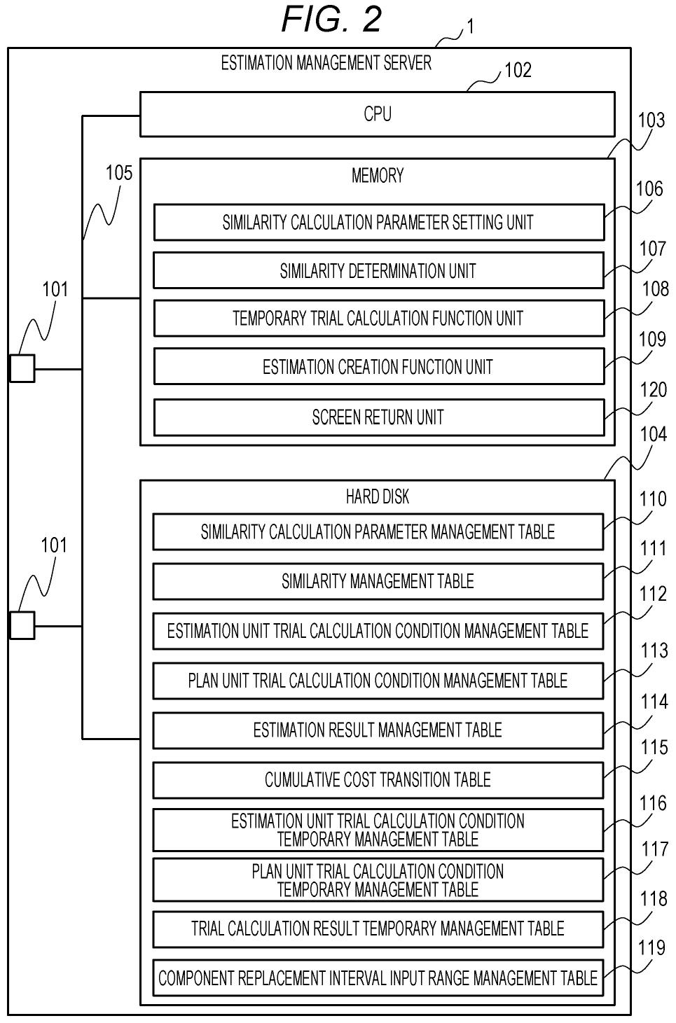

FIG. 2 is a block diagram illustrating an example of a configuration of the estimation management server 1. The estimation management server 1 includes a plurality of communication interfaces 101 connected to the terminals 2 via the network 3, a CPU 102 that is a processor, a memory 103, and a hard disk 104. Each component is connected by a bus 105. The memory 103, the hard disk 104, or a combination thereof is a storage device.

The memory 103 stores a similarity calculation parameter setting unit 106, a similarity determination unit 107, a temporary trial calculation function unit 108, an estimation creation function unit 109, and a screen return unit 120. The similarity calculation parameter setting unit 106 is a program that sets parameters for calculating the similarity in estimation conditions between a past estimation and a new project. The similarity determination unit 107 calculates the similarity in the estimation conditions between the past estimation and the new project. The temporary trial calculation function unit 108 is a program that diverts past estimation data to create a temporary estimation for the new project. The estimation creation function unit 109 is a program that creates an estimation for making a proposal to the client. The screen return unit 120 is a program that generates and returns information to be displayed on a terminal screen in response to a request from the terminals 2.

The CPU 102 operates in accordance with the programs stored in the memory 103 to implement various functional units. For example, the CPU 102 operates in accordance with corresponding programs to function as the similarity calculation parameter setting unit, the similarity determination unit, the temporary trial calculation function unit, the estimation creation function unit, and the screen return unit.

The processor may include one or more processing units, and may include one or more arithmetic units, or a plurality of processing cores. The processor may be implemented as one or more central processing units, a microprocessor, a microcomputer, a microcontroller, a digital signal processor, a state machine, a logic circuit, a graphics processing unit, a chip-on system, and/or any device that manipulates signals based on control instructions.

A function of the estimation management server 1 may be implemented in a computer system including one or more computer systems including one or more processors and one or more storage devices including a non-transitory storage medium. The plurality of computers communicates via a network. For example, a part of a plurality of functions of the estimation management server 1 may be implemented in one computer and another part may be implemented in another computer.

The hard disk 104 stores tables 110 to 119. A similarity calculation parameter management table 110 manages parameters for calculating the similarity in the estimation conditions between the past estimation and the new project. A similarity management table 111 manages the similarity in the estimation conditions between the past estimation and the new project. An estimation unit trial calculation condition management table 112 manages trial calculation conditions in estimation units included in the past estimation data. A plan unit trial calculation condition management table 113 manages trial calculation conditions in each plan unit of a proposed plan and a compared plan included in the past estimation. An estimation result management table 114 manages estimation results.

A cumulative cost transition table 115 manages a data series of cumulative cost transitions. An estimation unit trial calculation condition temporary management table 116 manages trial calculation conditions in estimation units included in estimation data of the new project temporarily created by diverting the past estimation data. A plan unit trial calculation condition temporary management table 117 manages trial calculation conditions in plan units included in the estimation data of the new project temporarily created by diverting the past estimation data. A trial calculation result temporary management table 118 manages trial calculation results of the new project temporarily created by diverting the past estimation data. A component replacement interval input range management table 119 manages a range of values that can be set as a component replacement interval of the industrial product.

The estimation management server 1 executes the similarity calculation parameter setting unit 106 and the similarity determination unit 107 to manage the similarity calculation parameter management table 110 and the similarity management table 111. As a result, a user can weight each trial calculation condition parameter according to an influence of the similarity on the trial calculation results. As a result, the user can evaluate the similarity reflecting the influence on the trial calculation results for each trial calculation condition parameter, and divert a past estimation having high similarity in creating an estimation for the new project.

Furthermore, the estimation management server 1 executes the temporary trial calculation function unit 108, to manage the estimation unit trial calculation condition management table 112, the plan unit trial calculation condition management table 113, the estimation result management table 114, the cumulative cost transition table 115, the estimation unit trial calculation condition temporary management table 116, the plan unit trial calculation condition temporary management table 117, and the trial calculation result temporary management table 118. As a result, the user can create trial calculation conditions of the new project by utilizing trial calculation conditions of the past estimation and confirm the trial calculation results. As a result, the user can efficiently create the trial calculation conditions of the new project and confirm the trial calculation results only by making a necessary correction to temporarily created trial calculation conditions, without inputting all trial calculation conditions.

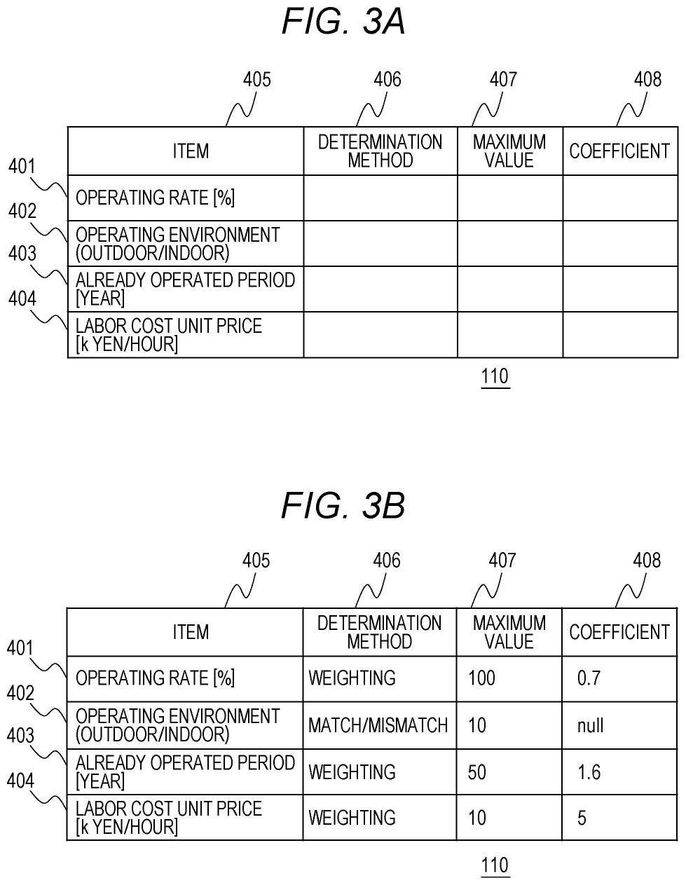

FIG. 3A is an example of the similarity calculation parameter management table 110. The similarity calculation parameter management table 110 manages correspondence among an item 405 for identifying the trial calculation condition parameters, a determination method 406 for the similarity in the item 405, a maximum value 407 in values of the item 405, and a coefficient 408 used in calculating the similarity in the item 405. The determination method 406 takes a value of either “weighting” or “match/mismatch”. The similarity calculation parameter management table 110 manages, as the item 405, information of an operating rate 401 of the industrial product to be estimated, an operating environment 402, an already operated period 403 indicating a total period operated so far, and a labor cost unit price 404 that an industrial plant operator who is the client spends on operating and maintaining the industrial product to be estimated. The already operated period 403 is referred to in an estimation of a maintenance service of an existing industrial product.

The similarity calculation parameter management table 110 manages the correspondence information of the similarity determination method 406, the maximum value 407, and the coefficient 408 for each item 405 of the trial calculation conditions, so that the estimation management server 1 can calculate the similarity weighted based on the determination method 406, the maximum value 407, and the coefficient 408 for each item 405 of the trial calculation conditions.

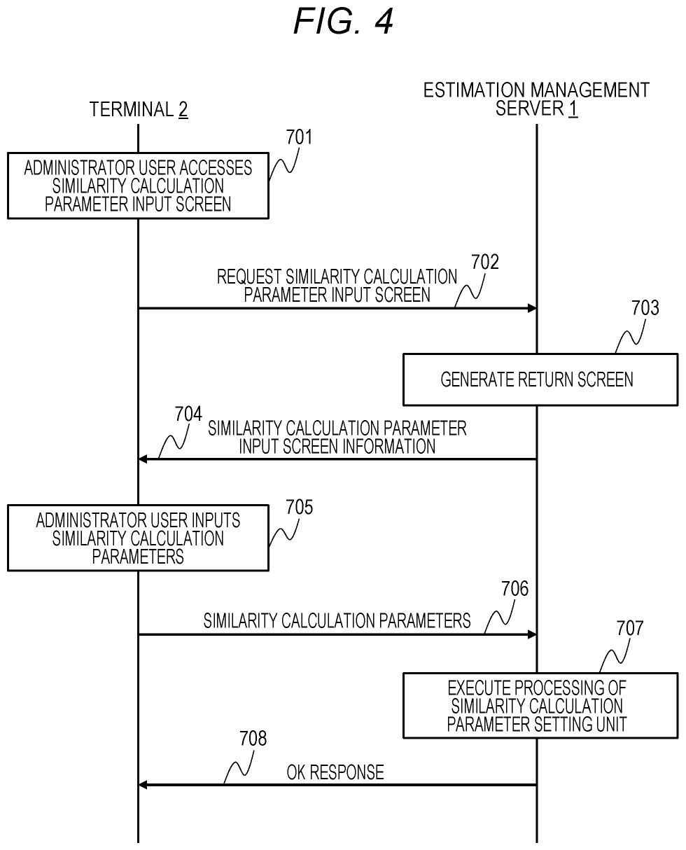

A procedure for the administrator user of the estimation management system to set the similarity calculation parameter management table 110 will be described according to a sequence illustrated in FIG. 4. The administrator user inputs a uniform resource identifier (URI) of a similarity calculation parameter input screen using a web browser installed in his/her terminal 2 (701).

As a result, the terminal 2 transmits a similarity calculation parameter input screen request message to the estimation management server 1 (702). Upon receiving the similarity calculation parameter input screen request, the estimation management server 1 generates a return screen by processing of the screen return unit 120 (703), and transmits similarity calculation parameter input screen information to the terminal 2 (704). As a result, the terminal 2 displays the similarity calculation parameter input screen.

The administrator user inputs, as similarity calculation parameters, one or more combination data of the item 405, the determination method 406, the maximum value 407, and the coefficient 408, which are information of the similarity calculation parameter management table 110 (705). As an example, following four combination data are input: (item 405, determination method 406, maximum value 407, coefficient 408)=(operating rate [%], weighting, 100, 0.7), (operating environment (outdoor/indoor), match/mismatch, 10, null), (already operated period, weighting, 50, 0.8), and (labor cost unit price [k yen/hour], weighting, 10, 5).

The terminal 2 transmits the similarity calculation parameters to the estimation management server 1 (706). Upon receiving the similarity calculation parameters, the estimation management server 1 executes processing of the similarity calculation parameter setting unit 106 (707).

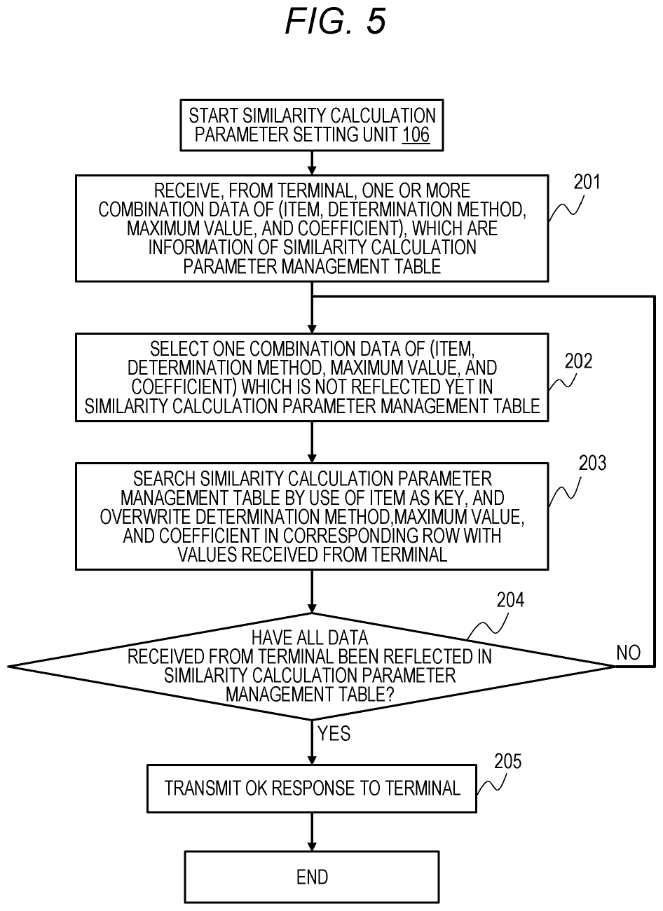

FIG. 5 illustrates each processing step of the similarity calculation parameter setting unit 106. In FIG. 5, upon receiving, from the terminal 2, one or more combination data of the item 405, the determination method 406, the maximum value 407, and the coefficient 408, which are the information of the similarity calculation parameter management table 110 (201), the similarity calculation parameter setting unit 106 proceeds to step 202.

Since none of the received data are reflected in the similarity calculation parameter setting unit 106, the similarity calculation parameter setting unit 106 selects one combination data from among the received data. Here, for example, IDs uniquely assigned to the combination data are selected in ascending order, and as a result, a combination data of (item 405, determination method 406, maximum value 407, coefficient 408)=(operating rate [%], weighting, 100, 0.7) is selected.

Subsequently, the similarity calculation parameter setting unit 106 specifies a row 401 by searching the similarity calculation parameter management table 110 using the item 405 as a key. The similarity calculation parameter setting unit 106 overwrites data of the row 401 with the received combination data of (item 405, determination method 406, maximum value 407, coefficient 408)=(operating rate [%], weighting, 100, 0.7) (203). Subsequently, the similarity calculation parameter setting unit 106 confirms whether all the combination data received from the terminal 2 have been reflected in the similarity calculation parameter management table 110 (204).

Since three combination data of (item 405, determination method 406, maximum value 407, coefficient 408)=(operating environment (outdoor/indoor), match/mismatch, 10, null), (already operated period, weighting, 50, 0.8), (labor cost unit price [k yen/hour], weighting, 10, 5) are not reflected in the similarity calculation parameter management table 110 yet, the similarity calculation parameter setting unit 106 repeats the processing of steps 202 to 204 again.

After reflecting all the combination data received from the terminal 2 in the similarity calculation parameter management table 110, the similarity calculation parameter setting unit 106 transmits an OK response to the terminal 2 and completes the processing (205). As a result, the similarity calculation parameter management table 110 in a state of FIG. 3A before the processing of the similarity calculation parameter setting unit 106 is started is updated to a state of FIG. 3B.

The estimation management server 1 calculates the similarity reflecting the weighting based on the determination method 406, the maximum value 407, and the coefficient 408 for each item 405 of the trial calculation conditions by the processing of the similarity calculation parameter setting unit 106. As a result, the estimation management server 1 can evaluate the similarity between estimations by weighting each item according to the influence of the similarity on the trial calculation results. Therefore, it is possible to utilize, in creating the estimation for the new project, a past estimation having high similarity in a value of an item that has a large influence on the trial calculation results.

Returning to FIG. 4, when the estimation management server 1 transmits an OK response to the terminal 2 (708), the procedure for setting the similarity calculation parameters is completed. As described above, the terminal 2 transmits the similarity calculation parameters input by the administrator user to the estimation management server 1, and the estimation management server 1 reflects the similarity calculation parameters in the similarity calculation parameter management table 110. As a result, the administrator user can set, in the estimation management server 1, the similarity calculation parameters according to the influence on the trial calculation results.

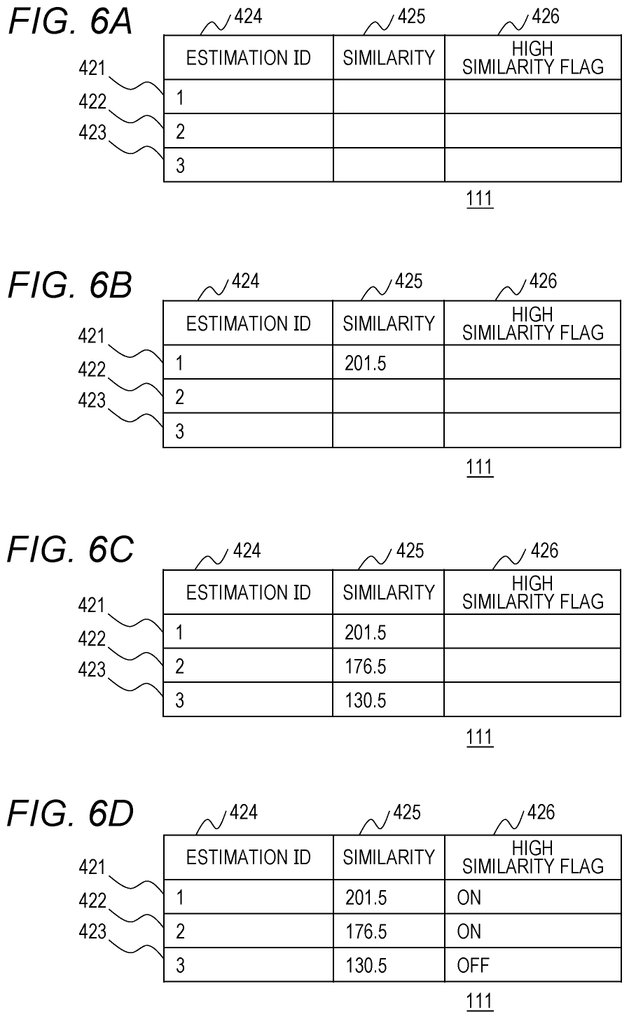

FIG. 6A is an explanatory diagram illustrating an example of the similarity management table 111. The similarity management table 111 manages correspondence among an estimation ID 424 that identifies a past estimation, similarity 425 between the past estimation identified by the estimation ID 424 and the estimation for the new project, and a high similarity flag 426 indicating high similarity or low similarity. A value of the high similarity flag 426 is “ON” when it is determined that the similarity is high, and is “OFF” in other cases. By referring to the high similarity flag 426, the estimation management server 1 can select, from among a plurality of past estimations, one having high similarity to the new project regarding the trial calculation conditions.

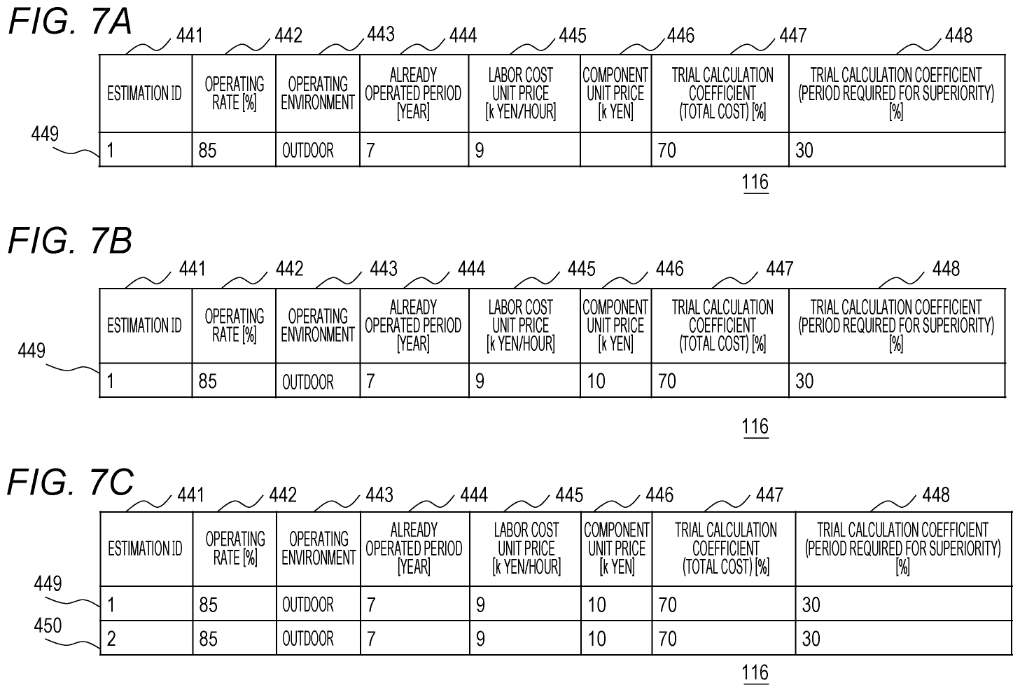

FIG. 7A is an explanatory diagram illustrating an example of the estimation unit trial calculation condition temporary management table 116 that manages the trial calculation conditions in estimation units included in the estimation data of the new project temporarily created by diverting the past estimation data. The estimation unit trial calculation condition temporary management table 116 manages correspondence among an estimation ID 441, an operating rate 442, an operating environment 443, an already operated period 444, a labor cost unit price 445, a component unit price 446, a trial calculation coefficient (total cost) 447, and a trial calculation coefficient (period required for superiority) 448.

The estimation ID 441 uniquely identifies a past estimation. The operating rate 442 indicates an operating rate of the industrial product to be estimated. The already operated period 444 indicates a total period that has been operated so far. The labor cost unit price 445 indicates a labor cost unit price that the industrial plant operator who is the client spends on operating and maintaining the industrial product to be estimated. The component unit price 446 indicates a component unit price of a replacement component of the industrial product to be estimated. The trial calculation coefficient (total cost) 447 represents a contribution of the total cost to evaluation of the estimation. The trial calculation coefficient (period required for superiority) 448 represents a contribution of the period required for superiority to the evaluation of the estimation.

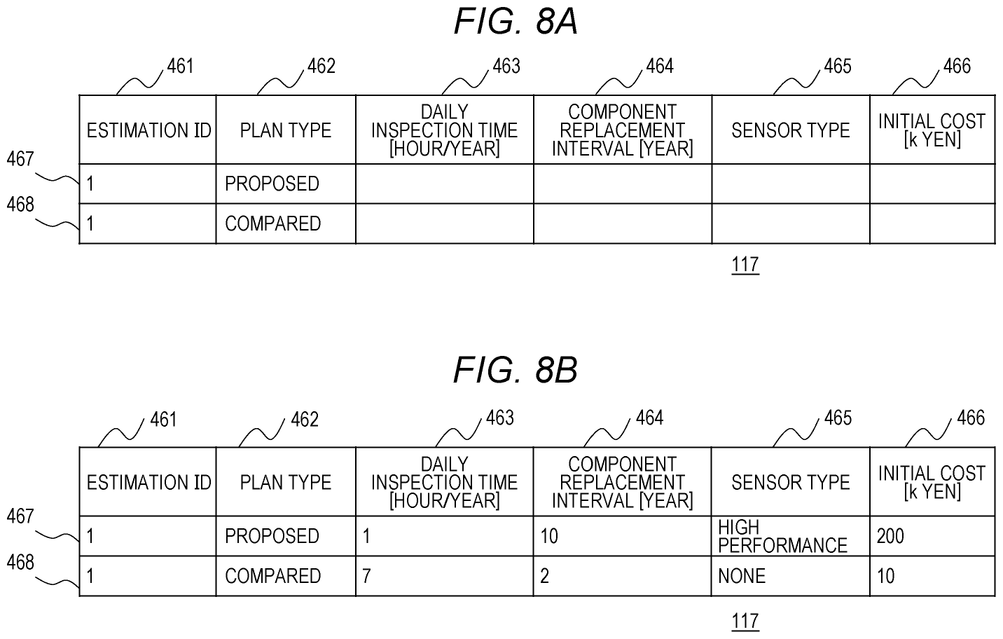

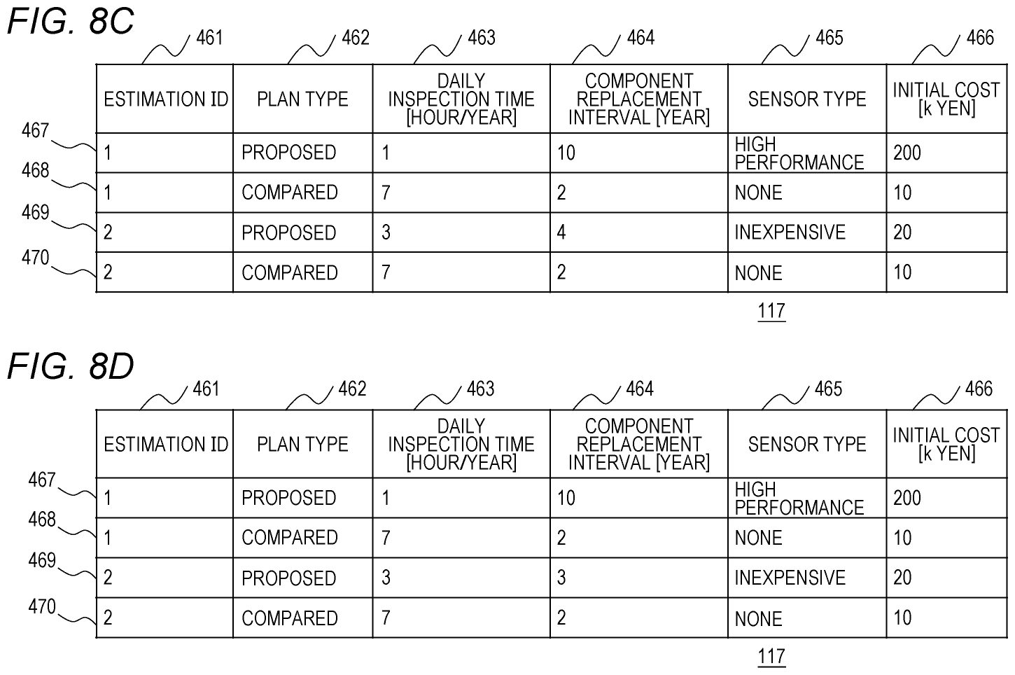

FIG. 8A is an explanatory diagram illustrating an example of the plan unit trial calculation condition temporary management table 117 that manages the trial calculation conditions in plan units included in the estimation data of the new project temporarily created by diverting the past estimation data. The plan unit trial calculation condition temporary management table 117 manages correspondence among an estimation ID 461, a plan type 462, a daily inspection time 463, a component replacement interval 464, a sensor type 465, and an initial cost 466.

The estimation ID 461 uniquely identifies a past estimation. The plan type 462 indicates whether the corresponding plan is the proposed plan or the compared plan. The daily inspection time 463 indicates a daily inspection time per year. The inspection is performed by the industrial plant operator who is the client for the industrial product to be estimated. The component replacement interval 464 indicates a frequency of component replacement. The sensor type 465 indicates whether a high-performance type sensor, an inexpensive type sensor, or no sensor is installed as a sensor attached for the purpose of remote monitoring and maintenance of the industrial product. The initial cost 466 indicates an initial cost incurred according to the sensor type 465.

By managing the estimation unit trial calculation condition temporary management table 116 and the plan unit trial calculation condition temporary management table 117, the estimation management server 1 can present, to the user, trial calculation conditions in a case where the past estimation identified by the estimation IDs 441 and 461 is diverted to the new project.

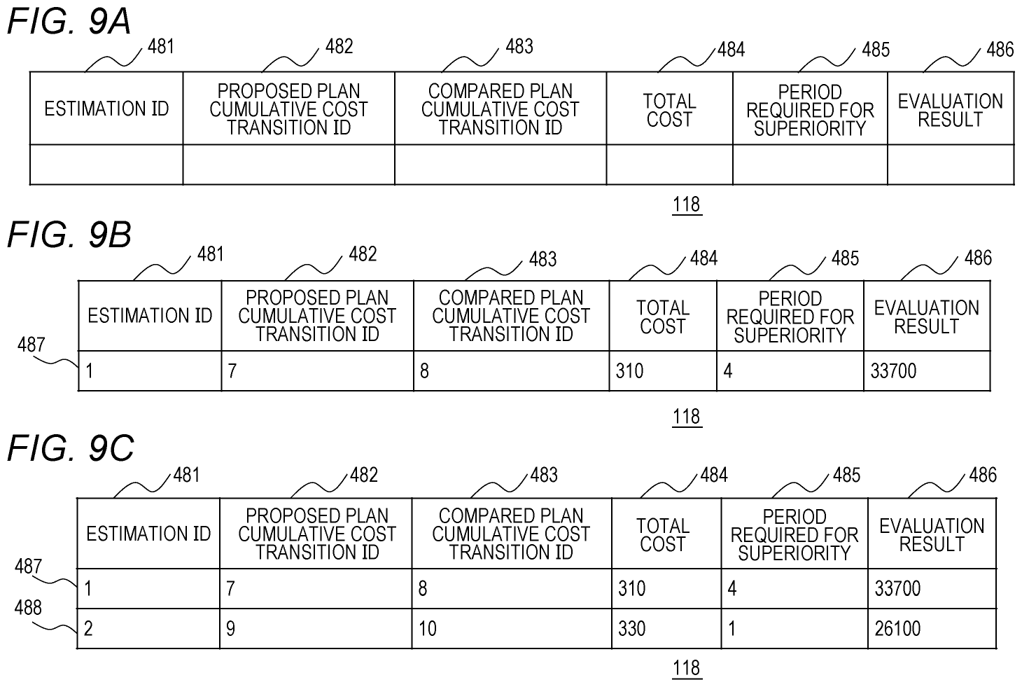

FIG. 9A is an explanatory diagram illustrating an example of the trial calculation result temporary management table 118 that manages the trial calculation results of the new project temporarily created by diverting the past estimation data. The trial calculation result temporary management table 118 manages correspondence among an estimation ID 481, a proposed plan cumulative cost transition ID 482, a compared plan cumulative cost transition ID 483, a total cost 484, a period 485 required for superiority, and an evaluation result 486.

The estimation ID 481 uniquely identifies a past estimation. The proposed plan cumulative cost transition ID 482 uniquely identifies a data series of a cumulative cost transition of the proposed plan. The compared plan cumulative cost transition ID 483 uniquely identifies a data series of a cumulative cost transition of the compared plan. The total cost 484 indicates a total cost of the proposed plan. The evaluation result 486 indicates results of evaluating temporary trial calculation results based on the trial calculation coefficient (total cost) 447 and the trial calculation coefficient (period required for superiority) 448 in the estimation unit trial calculation condition temporary management table 116. The smaller a value of the evaluation result 486 is, the higher the evaluation is.

By managing the trial calculation result temporary management table 118, the estimation management server 1 can present, to the user, a list of combination information of trial calculation results and the evaluation result 486 in a case where the past estimation is diverted. As a result, the user can select an estimation having a higher evaluation result from past estimations that are candidates for diversion and create the estimation for the new project.

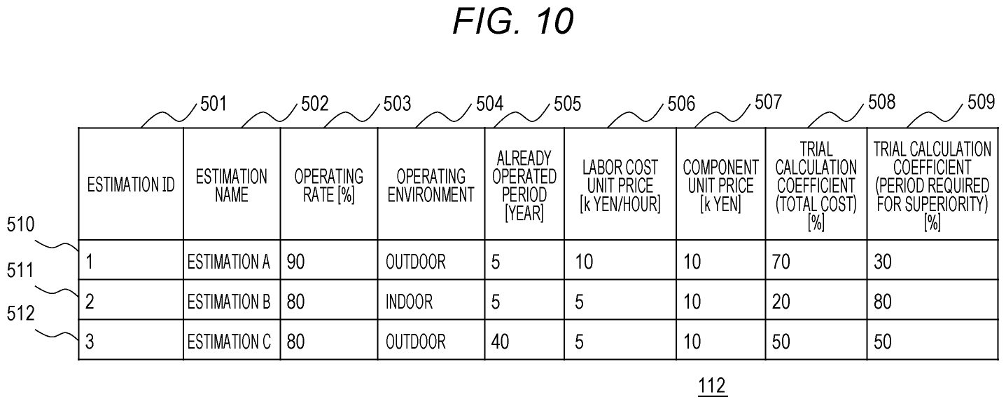

FIG. 10 is an explanatory diagram illustrating an example of the estimation unit trial calculation condition management table 112 that manages the trial calculation conditions in estimation units for the past estimation data. The estimation unit trial calculation condition management table 112 manages correspondence among an estimation ID 501, an estimation name 502, an operating rate 503, an operating environment 504, an already operated period 505, a labor cost unit price 506, a component unit price 507, a trial calculation coefficient (total cost) 508, and a trial calculation coefficient (period required for superiority) 509. In the example of FIG. 10, the estimation unit trial calculation condition management table 112 includes rows 510, 511, and 512 having values “1”, “2” and “3” of the estimation ID 501, respectively.

The estimation ID 501 uniquely identifies a past estimation. The operating rate 503 indicates an operating rate of the industrial product to be estimated. The already operated period 505 indicates a total period that has been operated so far. The labor cost unit price 506 indicates a labor cost unit price that the industrial plant operator who is the client spends on operating and maintaining the industrial product to be estimated. The component unit price 507 indicates a component unit price of the replacement component of the industrial product to be estimated. The trial calculation coefficient (total cost) 508 represents the importance of the total cost in evaluating the estimation. The trial calculation coefficient (period required for superiority) 509 represents the importance of the period required for superiority in evaluating the estimation.

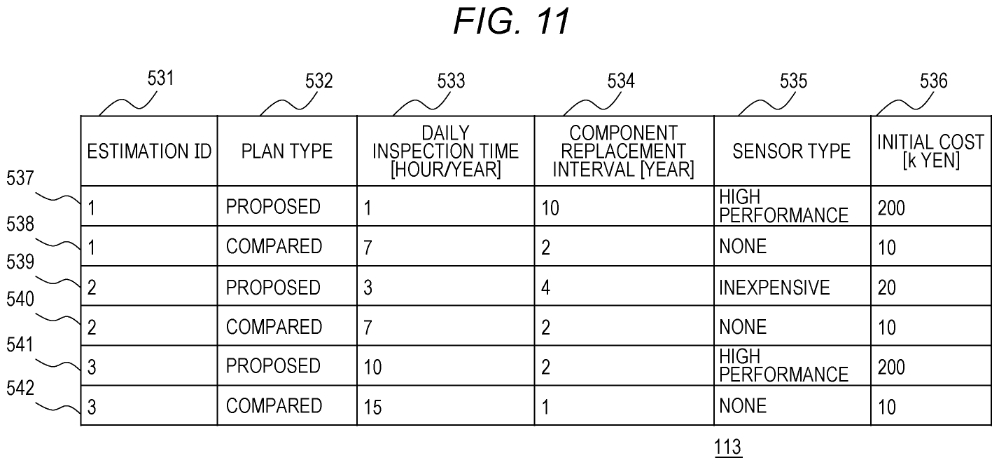

FIG. 11 is an explanatory diagram illustrating an example of the plan unit trial calculation condition management table 113 that manages the trial calculation conditions in each plan unit of the proposed plan and the compared plan included in the past estimation. The plan unit trial calculation condition management table 113 manages correspondence among an estimation ID 531, a plan type 532, a daily inspection time 533, a component replacement interval 534, a sensor type 535, and an initial cost 536. In the example of FIG. 11, the plan unit trial calculation condition management table 113 includes rows 537 to 542.

The estimation ID 531 uniquely identifies a past estimation. The plan type 532 indicates whether the corresponding plan is the proposed plan or the compared plan. The daily inspection time 533 indicates a daily inspection time per year. The inspection is performed by the industrial plant operator who is the client for the industrial product to be estimated. The component replacement interval 534 indicates a frequency of component replacement. The sensor type 535 indicates whether a high-performance type sensor, an inexpensive type sensor, or no sensor is installed as a sensor attached for the purpose of remote monitoring and maintenance of the industrial product. The initial cost 536 indicates an initial cost incurred according to the sensor type 535.

By managing the estimation unit trial calculation condition management table 112 and the plan unit trial calculation condition management table 113, the estimation management server 1 can present, to the user, trial calculation conditions in a case where the past estimation identified by the estimation IDs 501 and 531 is diverted to the new project.

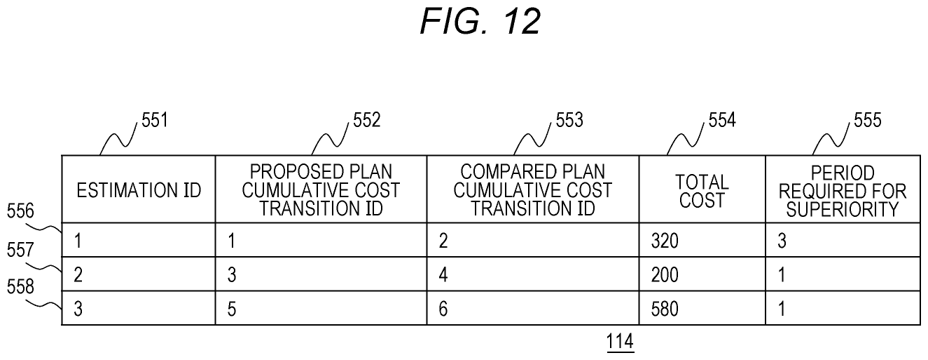

FIG. 12 is an explanatory diagram illustrating an example of the estimation result management table 114 that manages the estimation results. The estimation result management table 114 manages correspondence among an estimation ID 551, a proposed plan cumulative cost transition ID 552, a compared plan cumulative cost transition ID 553, a total cost 554, and a period 555 required for superiority. In the example of FIG. 12, the estimation result management table 114 includes rows 556, 557, and 558 having the values “1”, “2” and “3” of the estimation ID 551, respectively.

The estimation ID 551 uniquely identifies a past estimation. The proposed plan cumulative cost transition ID 552 uniquely identifies a data series of the cumulative cost transition of the proposed plan. The compared plan cumulative cost transition ID 553 uniquely identifies a data series of the cumulative cost transition of the compared plan. The total cost 554 indicates a total cost of the proposed plan.

The estimation management server 1 can present past estimation results to the user by managing the estimation result management table 114. As a result, the user can create the estimation for the new project while referring to past estimations.

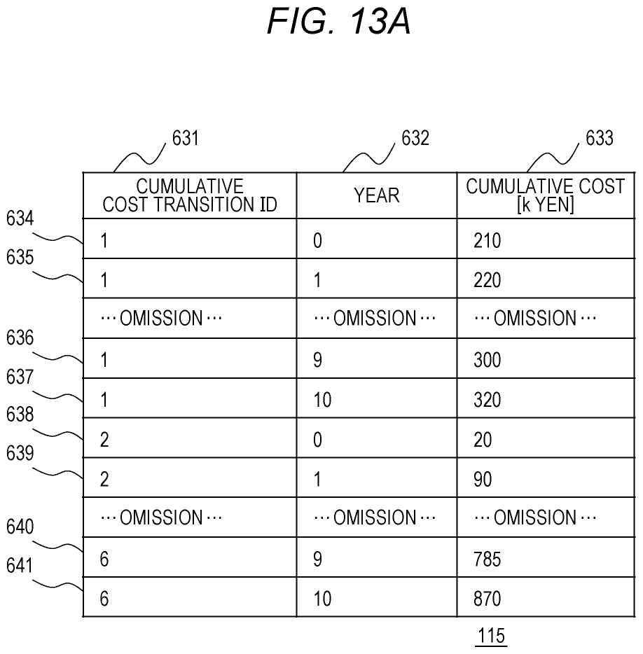

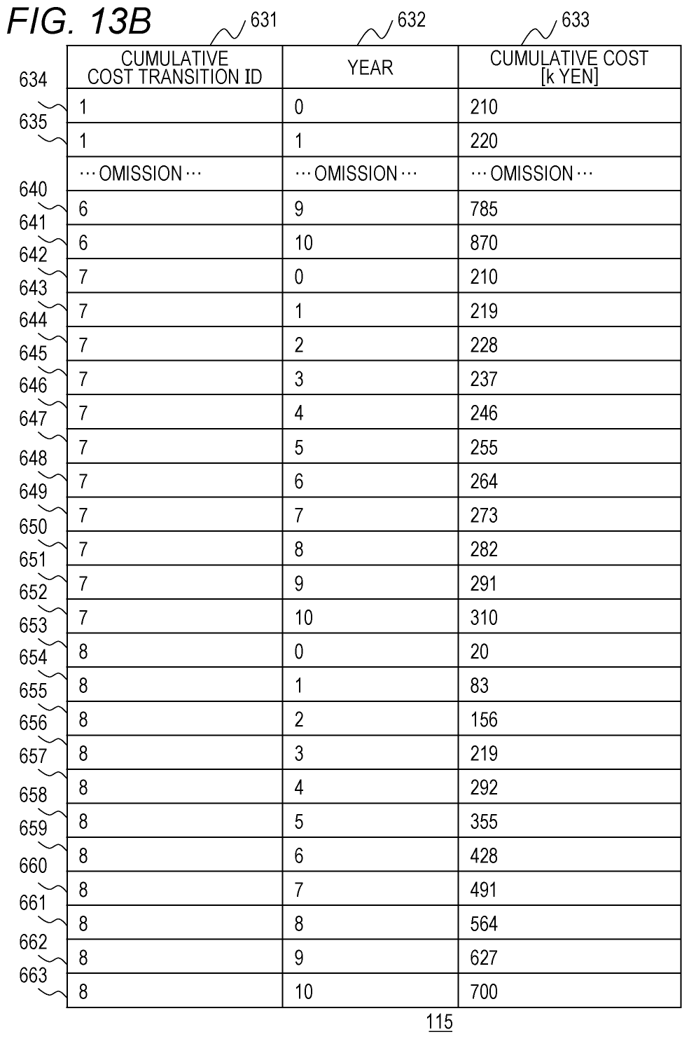

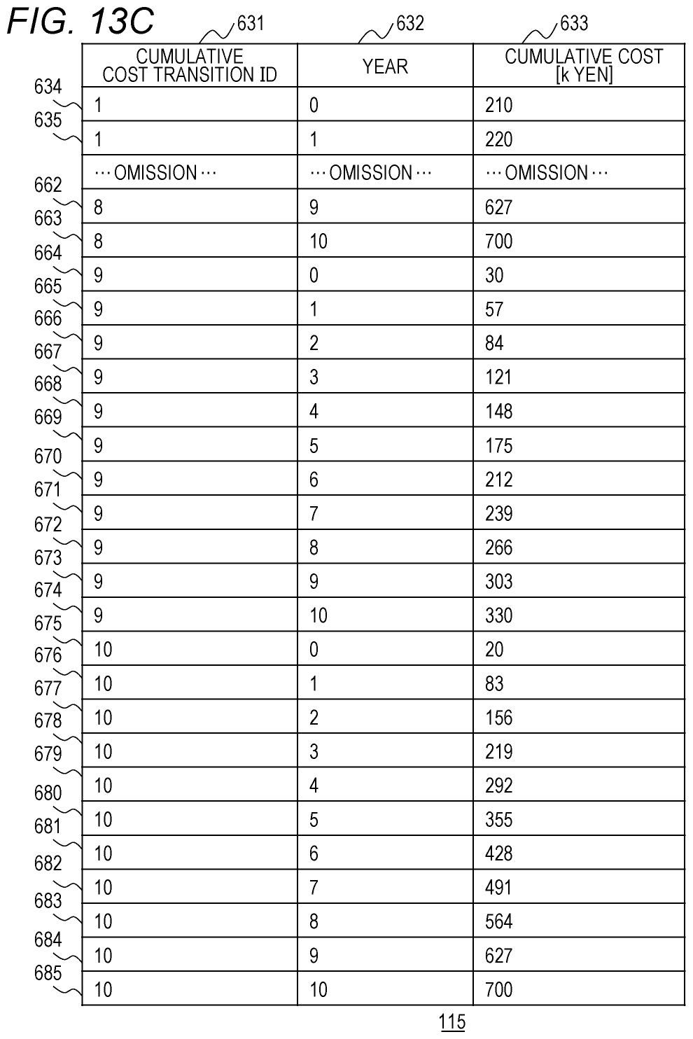

FIG. 13A is an explanatory diagram illustrating an example of the cumulative cost transition table 115. The cumulative cost transition table 115 manages correspondence among a cumulative cost transition ID 631 that uniquely identifies time series data of the cumulative cost transition, a year 632 representing elapsed years, and a cumulative cost 633 in the total elapsed years. In the example of FIG. 13A, the cumulative cost transition table 115 includes rows 634 to 641 having values “1” to “6” of the cumulative cost transition ID 631, respectively.

By managing the cumulative cost transition table 115, the estimation management server 1 can present, to the user, the cumulative cost transition obtained by the past estimation and a temporary trial calculation for a new estimation. As a result, the user can evaluate an appeal to the client in terms of the cumulative cost transition and consider a proposal method, for example, whether to emphasize superiority in terms of the cumulative cost or another characteristic.

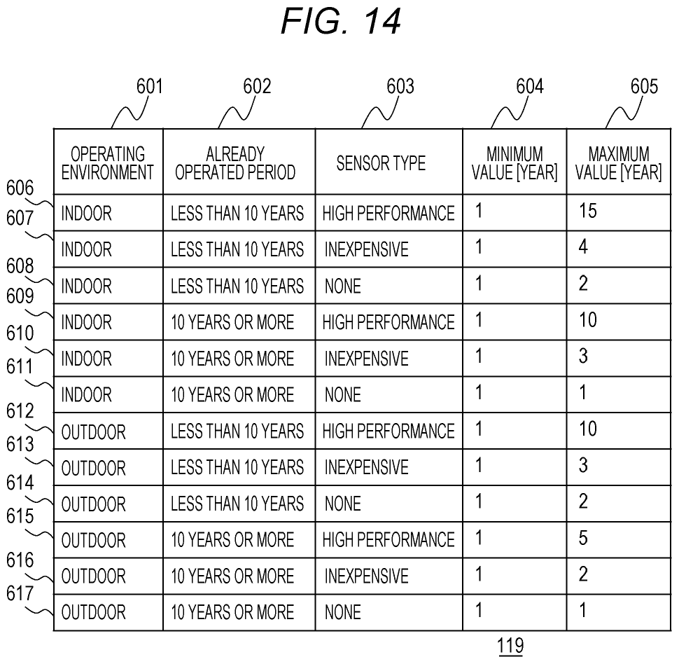

FIG. 14 illustrates an example of the component replacement interval input range management table 119 that manages the range of values that can be input as the component replacement interval of the industrial product. The component replacement interval input range management table 119 manages correspondence among an operating environment 601, an already operated period 602, a sensor type 603, a minimum value 604, and a maximum value 605. In the example of FIG. 14, the component replacement interval input range management table 119 includes rows 606 to 617.

The operating environment 601 indicates an operating environment of the industrial product. The already operated period 602 represents a period in which the industrial product has been operated so far. The sensor type 603 indicates whether a high-performance type sensor, an inexpensive type sensor, or no sensor is installed as a sensor attached for the purpose of remote monitoring and maintenance of the industrial product. The minimum value 604 represents a minimum value of a period that can be input as the component replacement interval. The maximum value 605 indicates a maximum value of a period that can be input as the component replacement interval.

By managing the component replacement interval input range management table 119, the estimation management server 1 can confirm whether a value of the component replacement interval, which is a trial calculation condition, is within the inputtable range, and correct the value to a value within the range if the value is out of the range. By setting the minimum value 604 and the maximum value 605 in the component replacement interval input range management table 119 to appropriate values in advance in terms of failure risks or the like, the industrial product maker can propose such an introduction/maintenance plan that the industrial plant operator can operate the industrial product stably for a long period of time.

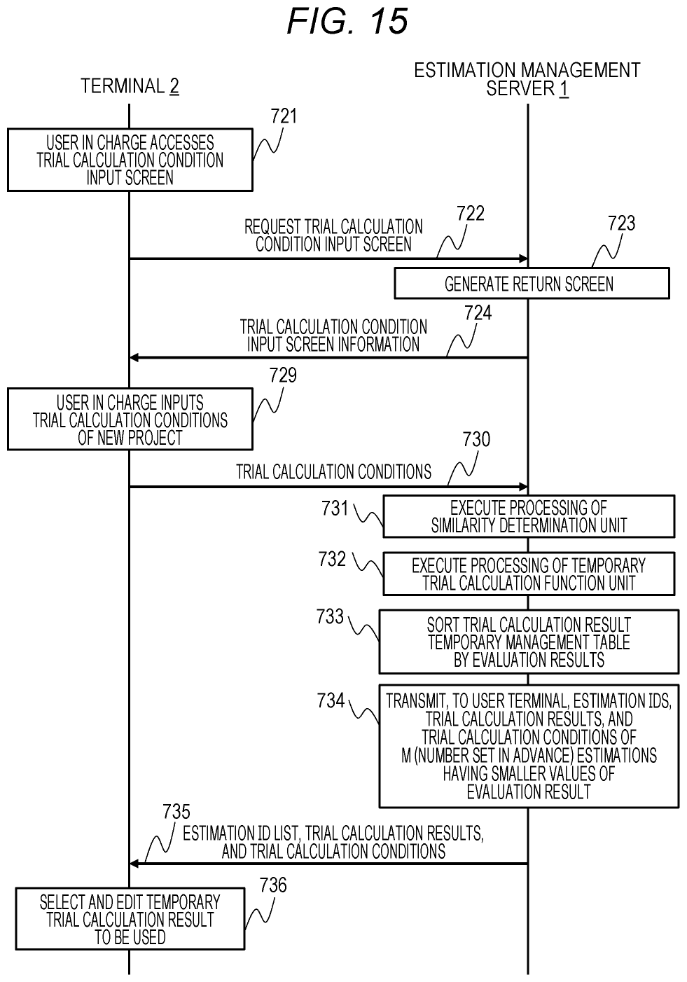

According to a sequence illustrated in FIG. 15, a procedure will be described with which the user in charge of the estimation management system inputs trial calculation conditions to create the estimation for the new project, and creates the estimation for the new project by diversion of a past estimation that is effective in creating a highly appealing estimation in terms of the total cost and the period required for superiority. The user in charge inputs the URI of a trial calculation condition input screen using a web browser installed in his/her terminal 2 (721).

As a result, the terminal 2 transmits a trial calculation condition input screen request message to the estimation management server 1 (722). Upon receiving the trial calculation condition input screen request, the estimation management server 1 generates a return screen by the processing of the screen return unit 120 (723), and transmits trial calculation condition input screen information to the terminal 2 (724). As a result, a trial calculation condition input screen is displayed on the terminal 2.

Next, the user in charge inputs trial calculation conditions confirmed in advance with the industrial plant operator who is the client of the new project (729). For example, the user in charge inputs the operating rate=“85%”, the operating environment=“outdoor”, the already operated period=“7 years”, the labor cost unit price=“9k yen/h”, the trial calculation coefficient (total cost)=“70%”, and the trial calculation coefficient (period required for superiority)=“30%”.

Here, the user in charge confirms, with the client, how much importance the industrial plant operator places on the total cost or the period required for superiority, and values of the trial calculation coefficient (total cost)=“70%” and the trial calculation coefficient (period required for superiority)=“30%” are set based on the confirmation results. Subsequently, the terminal 2 transmits the input trial calculation conditions to the estimation management server 1 (730). Receiving the trial calculation conditions, the estimation management server 1 executes processing of the similarity determination unit 107 (731).

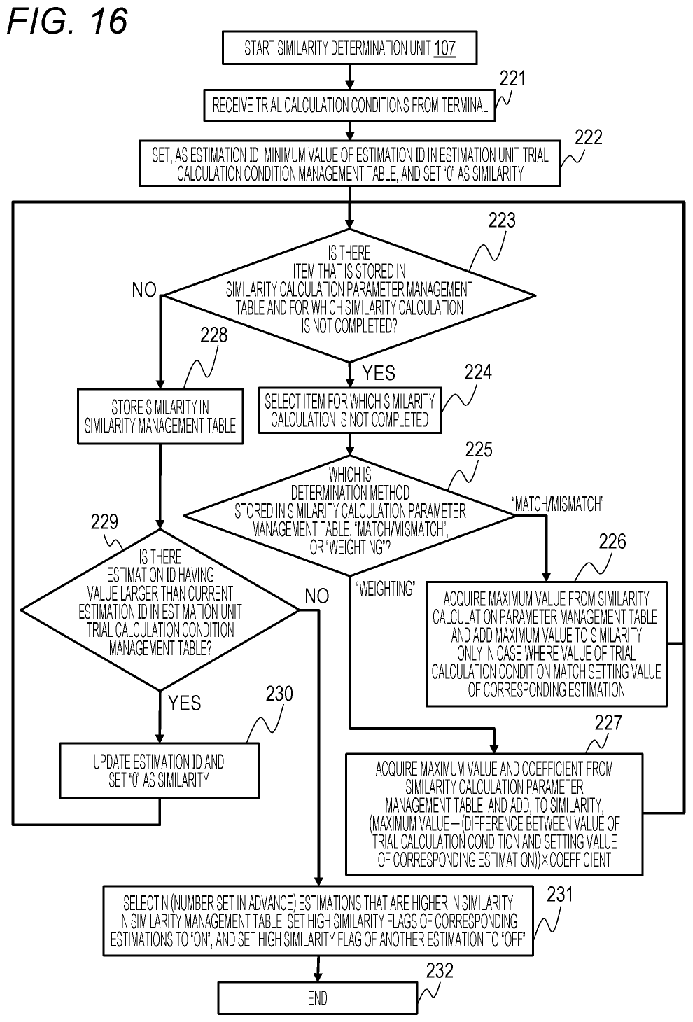

FIG. 16 illustrates each processing step of the similarity determination unit 107. In FIG. 16, the similarity determination unit 107 receives, from the terminal 2, the operating rate=“85%”, the operating environment=“outdoor”, the already operated period=“7 years”, the labor cost unit price=“9k yen/h”, the trial calculation coefficient (total cost)=“70%”, and the trial calculation coefficient (period required for superiority)=“30%”, as the trial calculation conditions, for example (221). Next, the similarity determination unit 107 sets, as the estimation ID, “1”, which is the minimum value of the estimation ID 501 in the estimation unit trial calculation condition management table 112, and sets an initial value “0” as the similarity (222).

Subsequently, the processing proceeds to step 223, and the similarity determination unit 107 confirms whether there is an item for which a similarity calculation is not completed among values of the items 405 stored in the similarity calculation parameter management table 110 illustrated in FIG. 3B. Since the similarity calculation is not completed yet, the “operating rate [%]”, which is the item 405 in the top row, is selected (224). Subsequently, the similarity determination unit 107 refers to the similarity calculation parameter management table 110 and confirms a value of the determination method 406 stored in the row 401 of the “operating rate [%]” (225).

Since the determination method 406 is “weighting”, the processing proceeds to step 227, and the similarity determination unit 107 acquires the maximum value 407 and the coefficient 408 in the corresponding row 401 in the similarity calculation parameter management table 110. Here, “100” is acquired as the maximum value 407 and “0.7” is acquired as the coefficient 408. Subsequently, the similarity determination unit 107 calculates (the maximum value 407−(a difference between a value of a trial calculation condition and a setting value of an estimation identified by an estimation ID))×the coefficient 408.

Here, the maximum value 407 is “100”, the value of the trial calculation condition is “85”, the setting value of the estimation identified by the estimation ID is “90”, which is obtained by referring to the operating rate 503 in the row 510 where the estimation ID 501 is “1” in the estimation unit trial calculation condition management table 112, and the coefficient 408 is “0.7”, so that the calculation result is (100−(an absolute value of a difference between 85 and 90))×0.7=66.5. The similarity determination unit 107 adds this value to the similarity, and the similarity mounts to “66.5”.

Subsequently, the processing returns to step 223, and the similarity determination unit 107 confirms whether there is an item for which the similarity calculation is not completed among the values of the items 405 stored in the similarity calculation parameter management table 110 illustrated in FIG. 3B. Since the similarity calculation is not completed for all the items 405, the processing proceeds to step 224, and the similarity determination unit 107 selects “operating environment (outdoor/indoor)” among the items 405 stored in the similarity calculation parameter management table 110. Subsequently, the similarity determination unit 107 refers to the similarity calculation parameter management table 110 and confirms a value of the determination method 406 stored in a row 402 of the “operating environment (outdoor/indoor)” (225).

Since the determination method 406 is “match/mismatch”, the processing proceeds to step 226, and the similarity determination unit 107 acquires “10” as the maximum value 407 in the corresponding row 402 in the similarity calculation parameter management table 110. Subsequently, the similarity determination unit 107 confirms whether the value of the trial calculation condition match the setting value of the estimation identified by the estimation ID. Here, the value of the trial calculation condition is “outdoor”, and the setting value of the estimation by the estimation ID is “outdoor”, which is obtained by referring to the operating environment 504 in the row 510 where the estimation ID 501 is “1” in the estimation unit trial calculation condition management table 112.

Since both values indicate “outdoor” and the values match, the similarity determination unit 107 adds a value “10” of the maximum value 407 to the similarity, and as a result, the similarity is 66.5+10=76.5 (227). Subsequently, the similarity determination unit 107 returns to step 223. If the value of the trial calculation condition does not match the setting value of the estimation identified by the estimation ID in step 226, the similarity determination unit 107 does nothing and returns to step 223.

Subsequently, the similarity determination unit 107 repeats the processing of steps 223 to 227. Furthermore, returning to step 223, when the similarity calculation is completed for all the items 405, the similarity determination unit 107 stores a calculation result of the similarity in a row where the estimation ID 424 in the similarity management table 111 is “1”, which is the current estimation ID. A similarity calculation result in a case where the estimation ID is “1” is “201.5”, and thus the similarity management table 111 is in a state of FIG. 6B.

Subsequently, the similarity determination unit 107 proceeds to step 229, and confirms whether a value larger than the value “1” of the current estimation ID is stored as the estimation ID 501 in the estimation unit trial calculation condition management table 112 (229). Since the value “2” is stored as the estimation ID 501 in the estimation unit trial calculation condition management table 112, the estimation ID is set to “2” and the similarity is set to the initial value “0” (230).

Subsequently, the processing returns to step 223, and the processing of steps 223 to 230 is repeated. As a result of repeating the processing of steps 223-230, when step 228 is completed in a state where the estimation ID is “3”, the similarity management table 111 is in a state of FIG. 6C. Subsequently, the processing proceeds to step 229, and when it is confirmed that a value larger than the current estimation ID “3” is not stored as the estimation ID 501 in the estimation unit trial calculation condition management table 112, the similarity determination unit 107 proceeds to step 231.

The similarity determination unit 107 selects a fixed number N of rows that are higher in the similarity 425 in the similarity management table 111, sets the high similarity flags 426 of the corresponding rows to “ON”, and sets the high similarity flag 426 of another row to “OFF”. Here, it is assumed that the number N is set in the system in advance, and here N=2 is set. As a result of the processing of step 231, the similarity management table 111 is in a state of FIG. 6D, and the processing of the similarity determination unit 107 ends (232).

By the processing of the similarity determination unit 107, the estimation management server 1 calculates, for all estimations stored in the estimation unit trial calculation condition management table 112, the similarity to the estimation of the new project in the trial calculation conditions, based on values stored in the similarity calculation parameter management table 110. As a result, the estimation management server 1 can extract only past estimations having high similarity and divert the estimations for creating the new estimation. As a result, it is possible for the user to shorten time required for creating an estimation.

Returning to FIG. 15, the estimation management server 1 subsequently executes processing of the temporary trial calculation function unit (732).

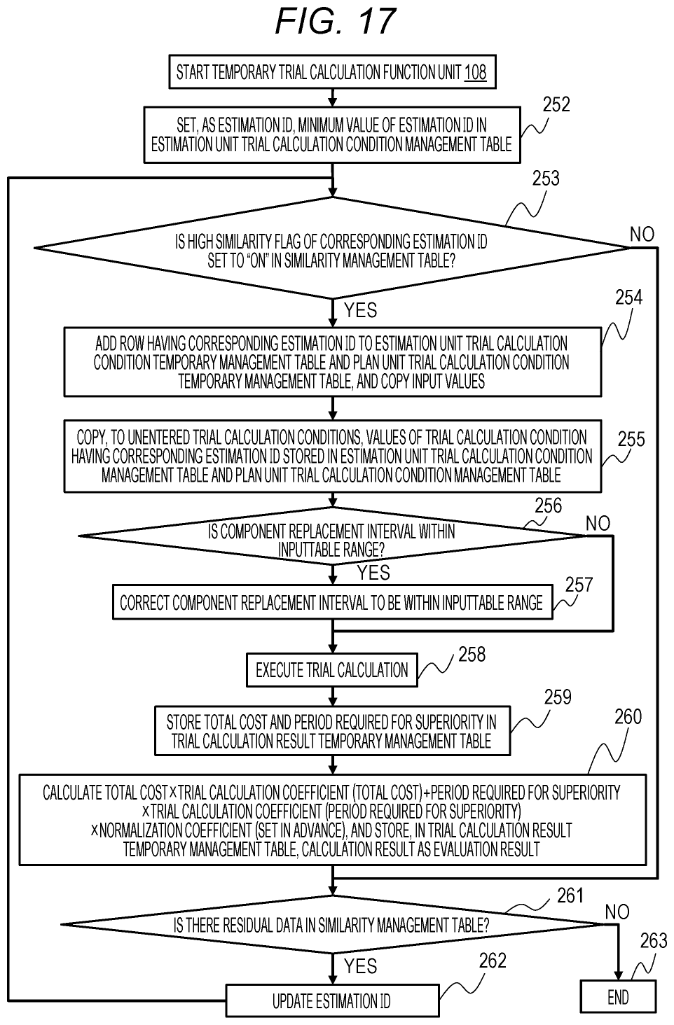

FIG. 17 illustrates each processing step of the temporary trial calculation function unit 108. In FIG. 17, when the processing is started, the temporary trial calculation function unit 108 sets “1”, which is the minimum value of the estimation ID 501 in the estimation unit trial calculation condition management table 112, as the estimation ID (252). Subsequently, the temporary trial calculation function unit 108 refers to a row 421 where the estimation ID 424 is “1” in the similarity management table 111 and confirms the value of the high similarity flag 426 (253).

The temporary trial calculation function unit 108 proceeds to step 254 if the high similarity flag is “ON”, and proceeds to step 261 if the high similarity flag is “OFF”. Here, since the high similarity flag is “ON”, the processing proceeds to step 254, and the temporary trial calculation function unit 108 adds a row having the value “1” of the estimation ID to the estimation unit trial calculation condition temporary management table 116 and the plan unit trial calculation condition temporary management table 117, and sets values of the trial calculation conditions received in step 730.

Specifically, the temporary trial calculation function unit 108 sets, in the row having the value “1” of the estimation ID in the estimation unit trial calculation condition temporary management table 116, the operating rate=“85%”, the operating environment=“outdoor”, the already operated period=“7 years”, the labor cost unit price=“9k yen/h”, the trial calculation coefficient (total cost)=“70%”, and the trial calculation coefficient (period required for superiority)=“30%”. As a result, the estimation unit trial calculation condition temporary management table 116 is in a state of FIG. 7A.

Subsequently, the temporary trial calculation function unit 108 sets, in an unentered trial calculation condition (trial calculation condition not specified by the user) in the estimation unit trial calculation condition temporary management table 116 and the plan unit trial calculation condition temporary management table 117, the same values as values in the rows where the estimation ID is “1” in the estimation unit trial calculation condition management table 112 and the plan unit trial calculation condition management table 113. Specifically, in order to input the component unit price 446 in the row having the value “1” of the estimation ID 441 in the estimation unit trial calculation condition temporary management table 116, the temporary trial calculation function unit 108 refers to the row 510 where the estimation ID 501 is “1” in the estimation unit trial calculation condition management table 112, and sets “10k yen”, which is a value of the component unit price 507.

Furthermore, the temporary trial calculation function unit 108 sets, in a row where the estimation ID 461 is “1” and the plan type 462 is “proposed” in the plan unit trial calculation condition temporary management table 117, values in the row 537 where the estimation ID 531 is “1” and the plan type 532 is “proposed” in the plan unit trial calculation condition management table 113. Specifically, a value “1” of the daily inspection time 533, a value “10” of the component replacement interval 534, a value “high performance” of the sensor type 535, and a value “200” of the initial cost 536 are set as the daily inspection time 463, the component replacement interval 464, the sensor type 465, and the initial cost 466, respectively.

Furthermore, the temporary trial calculation function unit 108 sets, in a row where the estimation ID 461 is “1” and the plan type 462 is “compared” in the plan unit trial calculation condition temporary management table 117, values in the row 538 where the estimation ID 531 is “1” and the plan type 532 is “compared” in the plan unit trial calculation condition management table 113. Specifically, a value “7” of the daily inspection time 533, a value “2” of the component replacement interval 534, a value “none” of the sensor type 535, and a value “10” of the initial cost 536 are set as the daily inspection time 463, the component replacement interval 464, the sensor type 465, and the initial cost 466, respectively. As a result, the estimation unit trial calculation condition temporary management table 116 is in a state of FIG. 7B, and the plan unit trial calculation condition temporary management table 117 is in a state of FIG. 8B.

Next, the temporary trial calculation function unit 108 confirms whether the component replacement interval 464 is within the inputtable range, for rows 467 and 468 where the estimation ID 461 is “1” in the plan unit trial calculation condition temporary management table 117 (256). In order to confirm whether the value “10 years” of the component replacement interval 464 in the row 467 is within the inputtable range, the temporary trial calculation function unit 108 refers to a row 449 where the estimation ID 441 is “1” in the estimation unit trial calculation condition temporary management table 116, and acquires the value “outdoor” of the operating environment 443, and the value “7 years” of the already operated period 444.

Subsequently, the temporary trial calculation function unit 108 refers to the plan unit trial calculation condition temporary management table 117, refers to the rows 467 and 468 where the estimation ID 461 is “1”, and acquires the value “high performance” of the sensor type 465 in a case where the plan type 462 is “proposed” and the value “none” of the sensor type 465 in a case where the plan type 462 is “compared”.

Next, in order to acquire a component replacement interval input range in a case where the plan type 462 is “proposed” based on the values acquired from the estimation unit trial calculation condition temporary management table 116 and the plan unit trial calculation condition temporary management table 117, the temporary trial calculation function unit 108 refers to the component replacement interval input range management table 119, refers to the row 612 where the operating environment 601 is “outdoor”, the already operated period 602 is “less than 10 years”, and the sensor type 603 is “high performance”, and acquires “1 year” as the minimum value 604 and “10 years” as the maximum value 605.

Furthermore, in order to acquire a component replacement interval input range in a case where the plan type 462 is “compared”, the temporary trial calculation function unit 108 refers to the row 614 where the operating environment 601 is “outdoor”, the already operated period 602 is “less than 10 years”, and the sensor type 603 is “none”. The temporary trial calculation function unit 108 acquires “1 year” as the minimum value 604 and “2 years” as the maximum value 605. The component replacement interval 464 stored in the rows 467 and 468 where the estimation ID 461 is “1” in the plan unit trial calculation condition temporary management table 117 is “10 years” in a case where the plan type is “proposed”, and is “2 years” in a case where the plan type is “compared”. Therefore, the temporary trial calculation function unit 108 determines that the component replacement interval 464 is within the inputtable range in both cases, and proceeds to step 258.

In step 258, the temporary trial calculation function unit 108 executes a trial calculation based on the estimation unit trial calculation condition temporary management table 116 and the plan unit trial calculation condition temporary management table 117. Specifically, first, a row 487 having the value “1” of the estimation ID is added to the trial calculation result temporary management table 118. Subsequently, the temporary trial calculation function unit 108 stores, in the proposed plan cumulative cost transition ID 482 in the trial calculation result temporary management table 118, a value “7” obtained by adding “1” to the maximum value of the cumulative cost transition ID 631 in the cumulative cost transition table 115 illustrated in FIG. 13A. Furthermore, the temporary trial calculation function unit 108 stores a value “8” obtained by adding “1” in the compared plan cumulative cost transition ID 483 in the trial calculation result temporary management table 118.

Next, the temporary trial calculation function unit 108 adds rows where the cumulative cost transition ID 631 in the cumulative cost transition table 115 is the value “7” of the proposed plan cumulative cost transition ID 482. The rows are added in correspondence with the number of years based on a predetermined trial calculation period. Here, assuming that the trial calculation period is 10 years, the temporary trial calculation function unit 108 adds 11 rows 642 to 652 where the cumulative cost transition ID 631 is “7” and values of the year 632 are “0” to “10”.

Subsequently, the temporary trial calculation function unit 108 stores “210k yen” as the cumulative cost 633 in a case where the year 632 is “0”. The value “210k yen” is a sum of the value “200k yen” of the initial cost 466 in the row where the estimation ID 461 is “1” and the plan type 462 is “proposed” in the plan unit trial calculation condition temporary management table 117 and the value “10k yen” of the component unit price 446 in the row where the estimation ID 441 is “1” in the estimation unit trial calculation condition temporary management table 116.

Furthermore, the temporary trial calculation function unit 108 calculates the cumulative cost 633 in the rows 643 to 652 in the cumulative cost transition table 115 by adding a component replacement cost and a labor cost, and stores the calculation results. Specifically, the value “10k yen” of the component unit price 446 as the component replacement cost is added every “10 years”, which are the value of the component replacement interval 464 in the row where the estimation ID 461 is “1” and the plan type 462 is “proposed” in the plan unit trial calculation condition temporary management table 117.

Furthermore, the temporary trial calculation function unit 108 adds “9k yen” as the labor cost every year. The value “9k yen” is obtained by multiplying the value “9k yen” of the labor cost unit price 445 in the row 449 where the estimation ID 441 is “1” in the estimation unit trial calculation condition temporary management table 116, by the value “1 hour/year” of the daily inspection time 463 in the row where the estimation ID 461 is “1” and the plan type 462 is “proposed” in the plan unit trial calculation condition temporary management table 117.

Subsequently, the temporary trial calculation function unit 108 adds rows where the cumulative cost transition ID 631 in the cumulative cost transition table 115 is the value “8” of the compared plan cumulative cost transition ID 483. The rows are added in correspondence with the number of years based on a predetermined trial calculation period. Here, assuming that the trial calculation period is 10 years, the temporary trial calculation function unit 108 adds 11 rows 653 to 663 where the cumulative cost transition ID 631 is “8” and values of the year 632 are “0” to “10”.

Subsequently, the temporary trial calculation function unit 108 stores “20k yen” as the cumulative cost 633 in a case where the year 632 is “0”. The value “20k yen” is a sum of the value “10k yen” of the initial cost 466 in the row where the estimation ID 461 is “1” and the plan type 462 is “compared” in the plan unit trial calculation condition temporary management table 117 and the value “10k yen” of the component unit price 446 in the row where the estimation ID 441 is “1” in the estimation unit trial calculation condition temporary management table 116.

Furthermore, the temporary trial calculation function unit 108 obtains the cumulative cost 633 in the rows 654 to 663 in the cumulative cost transition table 115 by adding the component replacement cost and the labor cost, and stores the calculation results. Specifically, the value “10k yen” of the component unit price 446 as the component replacement cost is added every “2 years”, which are the value of the component replacement interval 464 in the row where the estimation ID 461 is “1” and the plan type 462 is “compared” in the plan unit trial calculation condition temporary management table 117.

Furthermore, the temporary trial calculation function unit 108 adds “63k yen” as the labor cost every year. The value “63k yen” is obtained by multiplying the value “9k yen” of the labor cost unit price 445 in the row 449 where the estimation ID 441 is “1” in the estimation unit trial calculation condition temporary management table 116 by the value “7 hours/year” of the daily inspection time 463 in a row where the estimation ID 461 is “1” and the plan type 462 is “compared” in the plan unit trial calculation condition temporary management table 117.

As a result, the cumulative cost transition table 115 is in a state illustrated in FIG. 13B. Subsequently, the processing proceeds to step 259, and the temporary trial calculation function unit 108 stores, as the total cost 484 in the trial calculation result temporary management table 118, a value “310k yen” of the cumulative cost 663 of a final year of the trial calculation period, which is obtained when the cumulative cost 633 of the proposed plan is calculated in the cumulative cost transition table 115.

Furthermore, the temporary trial calculation function unit 108 determines, from cumulative cost transitions where the cumulative cost transition IDs 631 are “7” and “8” in the cumulative cost transition table 115, that a period required for the cumulative cost 633 of the proposed plan to fall below the cumulative cost 633 of the compared plan is 4 years, and stores “4 years” as a value of the period 485 required for superiority in the trial calculation result temporary management table 118.

Next, the temporary trial calculation function unit 108 proceeds to step 260, and calculates the total cost 484×the trial calculation coefficient (total cost) 447+the period 485 required for superiority×the trial calculation coefficient (period required for superiority) 448×a normalization coefficient set in advance. The normalization coefficient is set in advance by the administrator. For example, when the normalization coefficient set such that 100k yen of the total cost are equivalent to one year of the period required for superiority, 100÷1=100 is set.

Here, since the total cost 484 is “310k yen”, the trial calculation coefficient (total cost) 447 is “70%”, the period 485 required for superiority is “4 years”, the trial calculation coefficient (period required for superiority) 448 is “30%”, and the normalization coefficient is “100”, the calculation result is “33700”. Subsequently, the temporary trial calculation function unit 108 stores the calculation result “33700” as the evaluation result 486.

Next, the temporary trial calculation function unit 108 confirms whether there is residual data in the similarity management table 111 (261), and updates the estimation ID to the value “2” of the estimation ID 424, which is unprocessed (262). Subsequently, the processing returns to step 253. The processing of steps 253 to 255 is the same as the processing when the estimation ID is “1”. As a result of the processing of steps 253 to 255, the estimation unit trial calculation condition temporary management table 116 is in a state of FIG. 7C. In addition, the plan unit trial calculation condition temporary management table 117 is in a state of FIG. 8C.

Next, the temporary trial calculation function unit 108 confirms whether the component replacement interval 464 is within the inputtable range, for rows 469 and 470 where the estimation ID 461 is “2” in the plan unit trial calculation condition temporary management table 117 (256). In order to confirm whether a value “4 years” of the component replacement interval 464 in the row 469 is within the inputtable range, the temporary trial calculation function unit 108 refers to a row 450 where the estimation ID 441 is “2” in the estimation unit trial calculation condition temporary management table 116, and acquires the value “outdoor” of the operating environment 443, and the value “7 years” of the already operated period 444.

Subsequently, the temporary trial calculation function unit 108 refers to the plan unit trial calculation condition temporary management table 117, refers to the rows 469 and 470 where the estimation ID 461 is “2”, and acquires a value “inexpensive” of the sensor type 465 in a case where the plan type 462 is “proposed” and a value “none” of the sensor type 465 in a case where the plan type 462 is “compared”.

Next, in order to acquire a component replacement interval input range in a case where the plan type 462 is “proposed” based on the values acquired from the estimation unit trial calculation condition temporary management table 116 and the plan unit trial calculation condition temporary management table 117, the temporary trial calculation function unit 108 refers to the component replacement interval input range management table 119, refers to the row 613 where the operating environment 601 is “outdoor”, the already operated period 602 is “less than 10 years”, and the sensor type 603 is “inexpensive”, and acquires “1 year” as the minimum value 604 and “3 years” as the maximum value 605.

Furthermore, in order to acquire a component replacement interval input range in a case where the plan type 462 is “compared”, the temporary trial calculation function unit 108 refers to the row 614 where the operating environment 601 is “outdoor”, the already operated period 602 is “less than 10 years”, and the sensor type 603 is “none”, and acquires “1 year” as the minimum value 604 and “2 years” as the maximum value 605. The component replacement interval 464 stored in the rows 469 and 470 where the estimation ID 461 is “2” in the plan unit trial calculation condition temporary management table 117 is “4 years” in a case where the plan type is “proposed”, and is “2 years” in a case where the plan type is “compared”.

Therefore, the temporary trial calculation function unit 108 determines that the component replacement interval 464 is within the inputtable range in the case where the plan type is “compared”, but is outside the inputtable range in the case where the plan type is “proposed”. Therefore, the temporary trial calculation function unit 108 proceeds to step 257, and corrects the component replacement interval 464 in the row 469 where the estimation ID 461 is “1” and the plan type 462 is “proposed” in the plan unit trial calculation condition temporary management table 117, to “3 years”, which are the value within the inputtable range. As a result, the plan unit trial calculation condition temporary management table 117 is in a state of FIG. 8D.

Next, the temporary trial calculation function unit 108 proceeds to step 258. The processing of steps 258 to 260 is the same as the case where the estimation ID is “1”. As a result of the processing of steps 258 to 260, the trial calculation result temporary management table 118 is in a state of FIG. 9C with the addition of a row 488 having the value “2” of the estimation ID. Furthermore, the cumulative cost transition table 115 is in a state of FIG. 13C with the addition of rows 664 to 685 having values “9” and “10” of the cumulative cost transition ID 631.

Next, the temporary trial calculation function unit 108 confirms whether there is residual data in the similarity management table 111 (261), and updates the estimation ID to the value “3” of the estimation ID 424, which is unprocessed (262). Subsequently, the processing returns to step 253.

The temporary trial calculation function unit 108 refers to a row 423 where the estimation ID 424 is “3” in the similarity management table 111, confirms that the value of the high similarity flag 426 is OFF, and proceeds to step 261. Next, the temporary trial calculation function unit 108 confirms that there is no residual data in the similarity management table 111, and ends the processing (263).

The estimation management server 1 confirms the high similarity flag 426 by the processing of the temporary trial calculation function unit 108, and diverts a past estimation with high similarity to perform a temporary trial calculation for the new project. As a result, even a non-expert who has difficulty in setting detailed estimation conditions can utilize the past estimation and efficiently create the estimation of the new project. In addition, excluding past estimations having low similarity from diversion can shorten trial calculation time. Note that a part of past estimations or all past estimations may be diverted for a trial calculation without using the similarity.

Furthermore, the estimation management server 1 evaluates, by the processing of the temporary trial calculation function unit 108, the temporary trial calculation results based on the trial calculation coefficient (total cost) 447 and the trial calculation coefficient (period required for superiority) 448 set by the user in charge. As a result, the user in charge can create a highly appealing estimation according to how much importance the client places on the total cost or the period required for superiority.

Furthermore, the estimation management server 1 confirms whether the value of the component replacement interval 464 is within the inputtable range, and corrects the component replacement interval 464 in a case where the component replacement interval is outside the inputtable range. As a result, when copying estimation conditions of a past project to perform a trial calculation, even a user in charge who is not familiar with the inputtable range of the component replacement interval can create an estimation based on a value of a feasible component replacement interval.

Returning to FIG. 15, when the processing of the temporary trial calculation function unit 108 is completed, the estimation management server 1 sorts the trial calculation result temporary management table 118 in ascending order of values of the evaluation result 486 (733). Here, the smaller a value of the evaluation result 486 is, the higher an appeal of a trial calculation result to the client is.

Subsequently, the estimation management server 1 transmits, to the terminal 2, data of trial calculation results and trial calculation conditions having smaller values of the evaluation result 486 together with the estimation IDs (734). The data are transmitted by the number set in advance by the administrator user. Here, the number set in advance by the administrator user is two, and the estimation management server 1 transmits data where the estimation IDs are “1” and “2” to the user terminal 2 together with the estimation IDs (735). Upon receiving the trial calculation results and the trial calculation conditions where the estimation IDs are “1” and “2”, the user terminal displays the temporary trial calculation results on the screen.

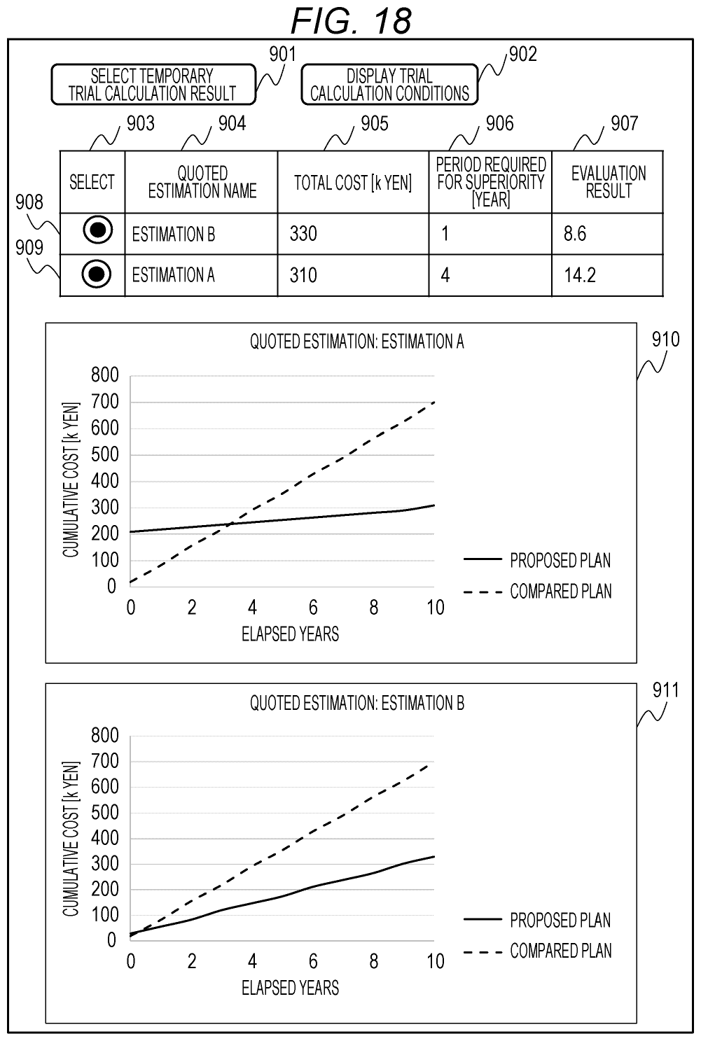

FIG. 18 illustrates an example of a temporary trial calculation result display screen for a new estimation. The temporary trial calculation result display screen includes a temporary trial calculation result selection button 901 for determining a temporary trial calculation adopted by the user in charge, a trial calculation condition display button 902 for displaying trial calculation conditions, an estimation list, and a graph.

The estimation list includes a selection radio button 903 for selecting a temporary trial calculation adopted by the user in charge or a trial calculation of which trial calculation conditions are displayed, a quoted estimation name 904 for the user in charge to identify diverted past estimations, a total cost 905, a period 906 required for superiority, and an evaluation result 907.

Furthermore, as graphs, graphs 910 and 911 respectively corresponding to temporary trial calculation results 908 and 909 displayed in the estimation list are displayed. Each graph is a line graph in which a horizontal axis indicates elapsed years and a vertical axis indicates the cumulative cost, and displays cumulative cost transitions of the proposed plan and the compared plan.

Returning to FIG. 15, the user in charge selects the radio button 903 by referring to the evaluation result 907 and the graphs 910 and 911 on the temporary trial calculation result display screen, and presses the temporary trial calculation result selection button 901 to start editing of the estimation based on the temporary trial calculation results (736). After that, the user in charge completes the creation of the estimation based on a general procedure for editing an estimation and makes a proposal to the client.

Through the above processing, the estimation management server 1 diverts the past estimation based on the trial calculation coefficient (total cost) 447, the trial calculation coefficient (period required for superiority) 448 and the trial calculation conditions of the new project input by the user in charge to make a temporary trial calculation, and presents the trial calculation conditions and the trial calculation results to the user in charge. As a result, the user in charge does not need to input all trial calculation conditions, and can correct only a part of the trial calculation conditions and make a trial calculation again by utilizing the temporary trial calculation results, to create the estimation for the new project.

Furthermore, the user in charge can select, from among a plurality of trial calculation results, an appropriate trial calculation result as a base for making an estimation highly appealing to the client by referring to the evaluation result 907 and the graphs 910 and 911 on the temporary trial calculation result display screen, to crate the estimation.

Note that the present invention is not limited to the above-described embodiment, and various modifications are included. For example, the above-described embodiment has been described in detail to describe the present invention in an easy-to-understand manner, and the present invention is not necessarily limited to an embodiment including all the configurations described. Furthermore, a part of a configuration of one embodiment can be replaced with a configuration of another embodiment, and a configuration of another embodiment can be added to a configuration of one embodiment. In addition, a part of a configuration of each embodiment may include an additional configuration, may be deleted, or may be replaced with another configuration.

Furthermore, the above-described configurations, functions, processing units, and the like may be partially or entirely implemented by hardware, for example, by being designed as an integrated circuit. In addition, the above-described configurations, functions, and the like may also be implemented by software by a processor interpreting and executing programs that implement the functions. Information such as programs, tables, and files that implement the functions may be stored in a storage device such as a memory, a hard disk or solid state drive (SSD), or a storage medium such as an IC card or an SD card.

Furthermore, as to control lines and information lines, only ones considered necessary for description are illustrated, and not all the control lines and the information lines for products are necessarily illustrated. It may be considered that almost all the configurations are actually connected to each other.

What is claimed is:

1. An estimation management system that creates and manages an estimation of a cost incurred for introduction of a device or a maintenance service, the estimation management system comprising:
one or more processors; and
one or more storage devices, wherein
the one or more storage devices store a plurality of past estimations each including a proposed plan and a compared plan,
each of the plurality of past estimations includes
a trial calculation condition for a trial calculation of a cost in an estimation period,
a transition of a cumulative cost of the proposed plan in the estimation period,
a trial calculation condition for a trial calculation of a cost of the compared plan in the estimation period,
a transition of the cumulative cost of the compared plan in the estimation period, and
a period required for superiority that represents a period required for the cumulative cost of the proposed plan to fall below the cumulative cost of the compared plan, and
the one or more processors
accept input of a trial calculation condition including a plurality of trial calculation condition items for a user to create a new estimation,
set, as a value of an unentered item in the plurality of trial calculation condition items, a value of a trial calculation condition item of each of a plurality of estimations selected from the plurality of past estimations to make a trial calculation, generate a plurality of trial calculation results corresponding to the plurality of estimations,
evaluate the plurality of trial calculation results in terms of a total cost and the period required for superiority, and
determine trial calculation results to be presented to the user from among the plurality of trial calculation results based on evaluation of the plurality of trial calculation results.

2. The estimation management system according to claim 1, wherein
the one or more processors include, in information to be presented to the user, the determined trial calculation results, a trial calculation condition of each of the determined trial calculation results, and information of a past estimation used for each of the determined trial calculation results.

3. The estimation management system according to claim 1, wherein
the one or more storage devices manage a coefficient for calculating similarity for each of the plurality of trial calculation condition items, and
the one or more processors
determine similarity between each of the plurality of past estimations and the input of the trial calculation condition based on a difference between input values of the plurality of trial calculation condition items in the input of the trial calculation condition and values of a plurality of trial calculation condition items of each of the plurality of past estimations, and the coefficient, and
select the plurality of estimations from the plurality of past estimations based on the similarity.

4. The estimation management system according to claim 1, wherein
the one or more storage devices manage an inputtable range of a value of a first trial calculation condition item in the plurality of trial calculation condition items and a condition of the inputtable range, and
when the first trial calculation condition item is the unentered item in the plurality of trial calculation condition items, the one or more processors refer to the inputtable range and the condition of the inputtable range, determine whether the value of the trial calculation condition item of each of the plurality of estimations is applicable, and correct a value that is not applicable.

5. The estimation management system according to claim 1, wherein
the one or more processors include, in information to be presented to the user, a list indicating a combination of the determined trial calculation results, a trial calculation condition of each of the determined trial calculation results, and information of a past estimation used for each of the determined trial calculation results in descending order of the evaluation.

6. The estimation management system according to claim 1, wherein
the one or more processors
accept input of a trial calculation coefficient representing importance of the total cost and a trial calculation coefficient representing importance of the period required for superiority, and
perform the evaluation based on a value based on the total cost and the trial calculation coefficient representing the importance of the total cost and a value based on the period required for superiority and the trial calculation coefficient representing the importance of the period required for superiority.

7. An estimation calculation method by an estimation management system that holds a plurality of past estimations each including a proposed plan and a compared plan,
each of the plurality of past estimations including
a trial calculation condition for a trial calculation of a cost in an estimation period,
a transition of a cumulative cost of the proposed plan in the estimation period,
a trial calculation condition for a trial calculation of a cost of the compared plan in the estimation period,
a transition of the cumulative cost of the compared plan in the estimation period, and
a period required for superiority that represents a period required for the cumulative cost of the proposed plan to fall below the cumulative cost of the compared plan,
the estimation calculation method comprising:
accepting input of a trial calculation condition including a plurality of trial calculation condition items for a user to create a new estimation,
setting, as a value of an unentered item in the plurality of trial calculation condition items, a value of a trial calculation condition item of each of a plurality of estimations selected from the plurality of past estimations to make a trial calculation, generating a plurality of trial calculation results corresponding to the plurality of estimations,
evaluating the plurality of trial calculation results in terms of a total cost and the period required for superiority, and
determining trial calculation results to be presented to the user from among the plurality of trial calculation results based on evaluation of the plurality of trial calculation results,
by the estimation management system.

8. The estimation calculation method according to claim 7, wherein
the estimation management system includes, in information to be presented to the user, the determined trial calculation results, a trial calculation condition of each of the determined trial calculation results, and information of a past estimation used for each of the determined trial calculation results.

9. The estimation calculation method according to claim 7, wherein
the estimation management system manages a coefficient for calculating similarity for each of the plurality of trial calculation condition items, and
the estimation calculation method comprises
determining, by the estimation management system, similarity between each of the plurality of past estimations and the input of the trial calculation condition based on a difference between input values of the plurality of trial calculation condition items in the input of the trial calculation condition and values of a plurality of trial calculation condition items of each of the plurality of past estimations, and the coefficient, and
selecting, by the estimation management system, the plurality of estimations from the plurality of past estimations based on the similarity.

10. The estimation calculation method according to claim 7, wherein
the estimation management system manages an inputtable range of a value of a first trial calculation condition item in the plurality of trial calculation condition items and a condition of the inputtable range, and
the estimation calculation method comprises
referring, when the first trial calculation condition item is the unentered item in the plurality of trial calculation condition items, to the inputtable range and the condition of the inputtable range, determining whether the value of the trial calculation condition item of each of the plurality of estimations is applicable, and correcting a value that is not applicable,
by the estimation management system.

11. The estimation calculation method according to claim 7, wherein
the estimation management system includes, in information to be presented to the user, a list indicating a combination of the determined trial calculation results, a trial calculation condition of each of the determined trial calculation results, and information of a past estimation used for each of the determined trial calculation results in descending order of the evaluation.

12. The estimation calculation method according to claim 7, wherein
the estimation management system
accepts, from the user, input of a trial calculation coefficient representing importance of the total cost and a trial calculation coefficient representing importance of the period required for superiority, and
performs the evaluation based on a value based on the total cost and the trial calculation coefficient representing the importance of the total cost and a value based on the period required for superiority and the trial calculation coefficient representing the importance of the period required for superiority.
